(19) United States
(12) Patent Application Publication
(10) Pub. No.: US 2026/0208334 A1
(43) Pub. Date: Jul. 23, 2026

(54) IMPACT TOOL INCLUDING ANVIL TORQUE SENSING

(71) Applicant: MILWAUKEE ELECTRIC TOOL CORPORATION, Brookfield, WI (US)

(72) Inventors: Jacob G. Wood, Waukesha, WI (US); John Michael Q. Van Treeck, Lannon, WI (US); Jacob P. Schneider, Cedarburg, WI (US); Maxwell L. Merget, Whitefish Bay, WI (US)

(21) Appl. No.: 19/451,143

(22) Filed: Jan. 16, 2026

Related U.S. Application Data
(60) Provisional application No. 63/746,688, filed on Jan. 17, 2025.

(51) Int. Cl. B25B 23/147; B25D 11/04

(52) U.S. Cl. CPC B25B 23/1475; B25D 11/04

(57) ABSTRACT

An impact tool includes a trigger, a motor including a motor shaft, and an impact mechanism. The impact mechanism includes a hammer coupled to the motor shaft, and an anvil configured to receive impacts from the hammer. The anvil includes anvil lugs, a shaft, an anvil strain sensor configured to sense an anvil strain, an amplifier connected to the anvil strain sensor, an analog to digital converter connected to the amplifier, and a wireless power and data transfer circuit. An output drive device is configured to be coupled to the anvil and configured to rotate to perform a task. A controller connected to the motor of the impact tool is configured to receive an output signal from the trigger, determine an anvil torque based on the anvil strain, and control the motor to operate based on the output signal from the trigger and the anvil torque.

### RELATED APPLICATIONS

This application claims the benefit of U.S. Provisional Patent Application No. 63/746,688, filed January 17, 2025, the entire content of which is hereby incorporated by reference.

### FIELD

This application relates to impact power tools.

### SUMMARY

Impact tools described herein may include a housing, a trigger, and a motor within the housing. The motor includes a rotor and a stator. The rotor is coupled to a motor shaft. An impact mechanism includes a hammer coupled to the motor shaft and an anvil configured to receive impacts from the hammer. The tool includes an output drive device coupled to the anvil and configured to rotate, and an electronic controller including a memory and an electronic processor. Sensors may be configured to detect a strain experienced by an anvil as a result of a torque applied to the anvil from the hammer impacting the anvil. The controller may be configured to determine the torque applied to the anvil based on the sensed strain.

Impact tools described herein may include a trigger and a motor (e.g., a brushless direct current [“DC”] motor, a brushed motor, an induction motor, etc.). The motor includes a motor shaft. The impact tools also include an impact mechanism, an output drive device, and a controller. The impact mechanism includes a hammer coupled to the motor shaft and an anvil configured to receive impacts from the hammer. The anvil includes anvil lugs and a shaft. An anvil strain sensor is configured to sense an anvil strain. An amplifier may be connected to the anvil strain sensor, an analog to digital converter, and a wireless power and data transfer circuit. The output drive device is configured to be coupled to the anvil and configured to rotate to perform a task. The controller is connected to the motor and configured to receive an output signal from the trigger, determine an anvil torque based on the anvil strain, and control the motor to operate based on the output signal from the trigger and the anvil torque.

Impact tools described herein include a trigger, a motor including a motor shaft, an impact mechanism, an output drive device, and a controller. The impact mechanism includes a hammer coupled to the motor shaft and an anvil configured to receive impacts from the hammer. The anvil includes anvil lugs, a shaft, an anvil strain sensor configured to sense an anvil strain, an amplifier connected to the anvil strain sensor, an analog to digital converter connected to the amplifier, and a wireless power and data transfer circuit. The output drive device is configured to be coupled to the anvil and is configured to rotate to perform a task. The controller is connected to the motor. The controller is configured to receive an output signal from the trigger and determine an anvil torque based on the anvil strain.

In some aspects, the controller is further configured to control the motor to operate based on the output signal from the trigger and the anvil torque.

In some aspects, the impact tool further includes a second anvil strain sensor positioned on a surface of the anvil.

In some aspects, the impact tool further includes a third anvil strain sensor positioned on the surface of the anvil and a fourth anvil strain sensor positioned on the surface of the anvil.

In some aspects, the anvil strain sensor, the second anvil strain sensor, the third anvil strain sensor, and the fourth anvil strain sensor are configured as a Wheatstone bridge circuit.

In some aspects, the anvil strain sensor is a capacitive strain gauge.

In some aspects, the wireless power and data transfer circuit includes an antenna, and the antenna includes a flexible substrate that is wrapped around a circumference of the anvil.

In some aspects, the antenna is configured to cover 180 degrees or more of the circumference of the anvil.

Impact tools described herein include a trigger, a motor including a motor shaft, an impact mechanism, an output drive device, and a controller. The impact mechanism includes a hammer coupled to the motor shaft and an anvil configured to receive impacts from the hammer. The anvil includes anvil lugs, a shaft, and an anvil strain sensor configured to sense an anvil strain. The output drive device is configured to be coupled to the anvil and is configured to rotate to perform a task. The controller is connected to the motor. The controller is configured to receive an output signal from the trigger, determine an anvil torque based on the anvil strain, and control the motor to operate based on the output signal from the trigger and the anvil torque.

In some aspects, the impact tool further includes a wireless power and data transfer circuit.

In some aspects, the wireless power and data transfer circuit includes one selected from a group consisting of: a capacitive coupling circuit and an inductive coupling circuit.

In some aspects, the wireless power and data transfer circuit includes an antenna, and the antenna includes a flexible substrate that is wrapped around a circumference of the anvil.

In some aspects, the antenna is configured to cover 180 degrees or more of the circumference of the anvil.

In some aspects, the anvil strain sensor is adhered to the anvil.

Methods described herein for controlling an impact power tool include sensing, via a strain sensing system, a strain applied to an anvil of the impact tool, determining, via a controller, a torque applied to anvil based on the sensed strain, and controlling, via the controller, a motor of the impact tool based on determined torque.

In some aspects, the method further includes transferring, using a wireless power transfer circuit, power to the anvil.

In some aspects, the wireless power transfer circuit includes one selected from a group consisting of: a capacitive coupling circuit and an inductive coupling circuit.

In some aspects, the method further includes transferring, a wireless data transfer circuit, data from the anvil to a controller of the impact power tool.

In some aspects, a data transfer rate of the wireless data transfer circuit is between 200 kilo-bytes per second (“kbps”) and 1000kbps.

In some aspects, the method further includes receiving an output signal from a trigger, and controlling the motor based on the output signal from the trigger.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of various embodiments will become apparent by consideration of the detailed description and accompanying drawings.

### BRIEF DESCRIPTION OF THE DRAWINGS

FIG. 1 illustrates an impact tool in accordance with embodiments described herein.

FIG. 2 is a schematic diagram of a controller of the impact tool of FIG. 1.

FIGS. 3A and 3B illustrate an example impact mechanism including a hammer and an anvil and configured to be used in the impact tool of FIG. 1.

FIG. 4 illustrates an anvil including a strain gauge for use in the impact tool of FIG. 1.

FIG. 5 illustrates an anvil including an arrangement of a plurality of strain gauges for use in the impact tool of FIG. 1.

FIG. 6 illustrates an anvil including an arrangement of a plurality of strain gauges for use in the impact tool of FIG. 1.

FIG. 7 illustrates a capacitive strain gauge for use in the impact tool of FIG. 1.

FIG. 8 illustrates a Wheatstone bridge circuit configured for use with a strain gauge in the impact tool of FIG. 1.

FIG. 9 illustrates a near field communications antenna for use in the impact tool of FIG. 1.

FIGS. 10A, 10B and 10C illustrate near field communication antennas for use in the impact tool of FIG. 1.

FIG. 11 illustrates a capacitive coupling circuit configured for use in the impact tool of FIG. 1.

FIG. 12 illustrates an inductive coupling circuit configured for use in the impact tool of FIG. 1.

FIG. 13 illustrates a wirelessly powered sensing circuit board and strain gauge affixed to an anvil for use in the impact tool of FIG. 1.

FIG. 14 illustrates a wirelessly powered sensing circuit board and strain gauge affixed to an anvil for use in the impact tool of FIG. 1.

FIG. 15 illustrates an anvil including a strain gauge and amplification integrated circuit for use in the impact tool of FIG. 1.

FIG. 16 illustrates an anvil having a magnetized surface configured to be sensed via magnetometers and for use in the impact tool of FIG. 1.

FIG. 17 illustrates an anvil having a magnetized surface configured to be sensed via passive coils and for use in the impact tool of FIG. 1.

FIGS. 18A and 18B illustrate a two-part anvil for use in the impact tool of FIG. 1.

FIGS. 19A, 19B, and 19C illustrate rate of change readings from magnetometers or coils during an impact to the anvil having a magnetized surface.

FIG. 20 illustrates an anvil configured to interact with an electromagnetic field produced by a transmitting coil of a power tool and for use in the impact tool of FIG. 1.

FIG. 21 illustrates a sensor assembly configured to excite the transmitting coil represented in FIG. 20, and to sense, via two receiving coils, a change in the electromagnetic field produced by the excited transmitting coil and for use in the impact tool of FIG. 1.

FIG. 22A illustrates an oscillating voltage signal applied to the transmitting coil of FIG. 21.

FIG. 22B illustrates signals read by the sensor assembly of FIG. 21 when the receiving coils are excited by an electromagnetic field produced by the transmitting coil and when no torque is applied to the anvil.

FIG. 22C illustrates a graph of a voltage signal produced when the voltage signals shown in FIG. 22B are subtracted from one another.

FIG. 23A illustrates an oscillating voltage signal applied to the transmitting coil of FIG. 21.

FIG. 23B illustrates signals read by the sensor assembly of FIG. 21 when the receiving coils are excited by an electromagnetic field produced by the transmitting coil and when a positive torque is applied to the anvil.

FIG. 23C illustrates a graph of a voltage signal produced when the voltage signals shown in FIG. 23B are subtracted from one another.

FIG. 24A illustrates an oscillating voltage signal applied to the transmitting coil of FIG. 21.

FIG. 24B illustrates signals read by the sensor assembly of FIG. 21 when the receiving coils are excited by an electromagnetic field produced by the transmitting coil and when a negative torque of is applied to the anvil.

FIG. 24C illustrates a graph of a voltage signal produced when the voltage signals shown in FIG. 24B are subtracted from one another.

FIG. 25 illustrates an anvil torque sensing configuration including an air transformer for use in the impact tool of FIG. 1.

FIG. 26 illustrates a surface acoustic wave sensor for use in the impact tool of FIG. 1.

FIG. 27 illustrates a wireless sensor interrogation system for the surface acoustic wave sensor of FIG. 26.

FIG. 28 illustrates a surface acoustic wave sensor affixed to an anvil for use in the impact tool of FIG. 1.

FIG. 29 illustrates a sensor assembly including a wireless sensor interrogation system for the surface acoustic wave sensor of FIG. 28.

FIG. 30 illustrates a flowchart for a method of controlling a motor based on anvil torque resulting from an impact to an anvil of an impact mechanism.

### DETAILED DESCRIPTION

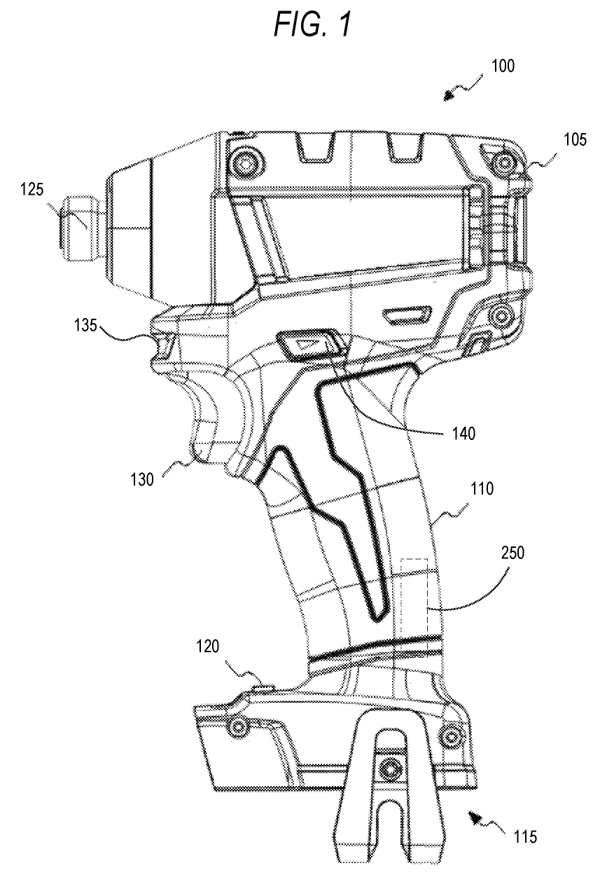

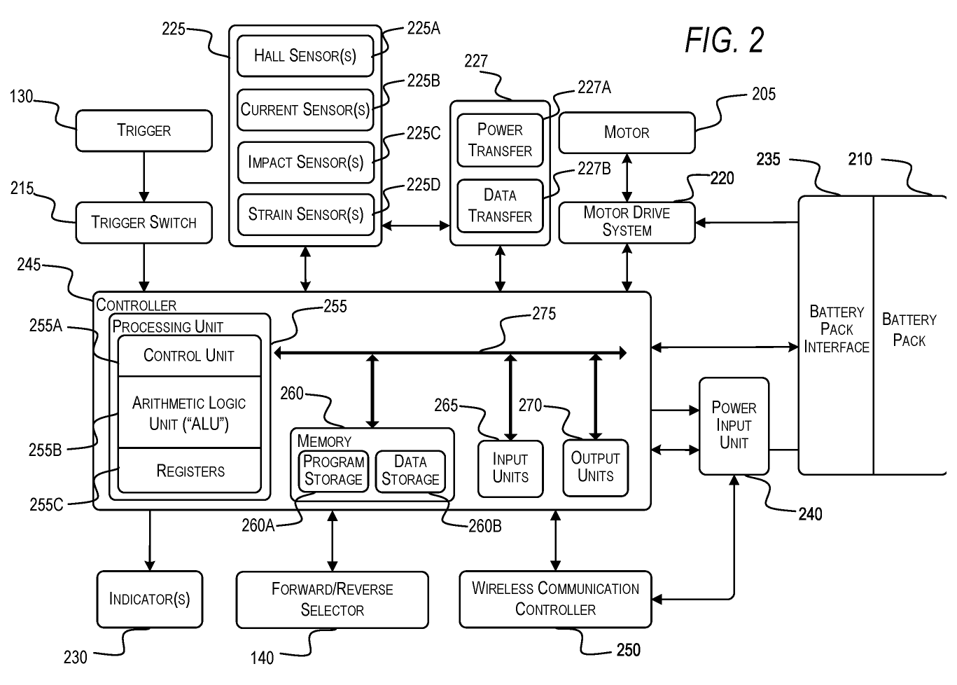

FIG. 1 illustrates a power tool 100, in particular an impact tool (e.g., an impact driver, an impact wrench, a hammer drill, etc.) associated with the task of generating a rotational output (e.g., to drive a bit). The impact tool 100 includes an upper main body 105, a handle 110, a battery pack receiving portion 115, a mode pad 120, an output drive device 125, a trigger 130, a work light 135, and a forward/reverse selector 140. The housing of the impact tool 100 (e.g., the main body 105 and the handle 110) are composed of, for example, a durable and light-weight plastic material or metal. The drive device 125 is composed of, for example, a metal (e.g., steel). In some embodiments, the drive device 125 on the impact tool 100 is a socket configured to receive a bit. The battery pack receiving portion 115 is configured to receive and couple to a battery pack (e.g., battery pack 210 of FIG. 2) that provides power to the impact tool 100. The battery pack receiving portion 115 includes a connecting structure to engage a mechanism that secures the battery pack and a terminal block to electrically connect the battery pack to the impact tool 100. The mode pad 120 allows a user to select a mode of the impact tool 100 and indicates to the user the currently selected mode of the impact tool 100, such as, for example, modes associated with differing torque levels or impact thresholds.

As shown in FIG. 2, the impact tool 100 also includes a motor 205 (e.g., a brushless direct current [“DC”] motor, a brushed motor, an induction motor, etc.). The motor 205 actuates the drive device 125 and provides the output torque to drive the bit. A primary power source or battery pack 210 couples to the impact tool 100 and provides electrical power to energize the motor 205. The motor 205 is energized based on, for example, the position of the trigger 130. When the trigger 130 is depressed, the motor 205 is energized, and when the trigger 130 is released, the motor 205 is de-energized. In the illustrated embodiment, the trigger 130 extends partially down a length of the handle 110. However, in other embodiments, the trigger 130 may be positioned elsewhere on the impact tool 100 or extend a different length down the handle. The trigger 130 is moveably coupled to the handle 110 such that the trigger 130 moves with respect to the tool housing. The trigger 130 moves in a first direction toward the handle 110 when the trigger 130 is depressed by the user. The trigger 130 is biased (e.g., with a spring) such that the trigger 130 moves in a second direction away from the handle 110 when the trigger 130 is released by the user. In some embodiments, when the trigger 130 is depressed by the user, a push rod activates the trigger switch 215, and when the trigger 130 is released by the user, the trigger switch 215 is deactivated. In other embodiments, the trigger 130 is coupled to an electrical trigger switch 215. In such embodiments, the trigger switch 215 may include, for example, a transistor. Additionally, for such electronic embodiments, the trigger 130 may not include a push rod to activate the mechanical switch. Rather, the electrical trigger switch 215 may be activated by, for example, a non-contact position sensor (e.g., a Hall-Effect sensor) that provides information about the relative position of the trigger 130.

The trigger switch 215 outputs a signal indicative of the position of the trigger 130. In some instances, the signal is binary and indicates either that the trigger 130 is depressed or released. In other instances, the signal indicates the position of the trigger 130 with more precision. For example, the trigger switch 215 may output an analog signal that various from 0 to 5 volts depending on the extent that the trigger 130 is depressed. For example, 0V output indicates that the trigger 130 is released, 1V output indicates that the trigger 130 is 20% depressed, 2V output indicates that the trigger 130 is 40% depressed, 3V output indicates that the trigger 130 is 60% depressed 4V output indicates that the trigger 130 is 80% depressed, and 5V indicates that the trigger 130 is 100% depressed. Put another way, the amount of pull provided by the user on the trigger 130 can determine the amount of power provided at the motor 205. The signal output by the trigger switch 215 may be analog or digital.

As also shown in FIG. 2, the impact tool 100 includes a motor drive system 220, sensors 225, indicators 230, a battery pack interface 235, a power input unit 240, a controller 245, and a wireless communication controller 250. The battery pack interface 235 is connected to the controller 245 and couples to the battery pack 210. The battery pack interface 235 includes a combination of mechanical (e.g., the battery pack receiving portion 115) and electrical components configured to and operable for interfacing (e.g., mechanically, electrically, and communicatively connecting) the impact tool 100 with the battery pack 210. The battery pack interface 235 is coupled to the power input unit 240. The battery pack interface 235 transmits the power received from the battery pack 210 to the power input unit 240. The power input unit 240 includes active and/or passive components (e.g., voltage step-down controllers, voltage converters, rectifiers, filters, etc.) to regulate or control the power received through the battery pack interface 235 and to the wireless communication controller 250 and controller 245.

In some embodiments, the motor drive system 220 enables the controller 245 to control the operation of the motor 205. Generally, when the trigger 130 is depressed as indicated by an output of the trigger switch 215, electrical current is supplied from the battery pack interface 235 to the motor 205, via the motor drive system 220. When the trigger 130 is not depressed, electrical current is not supplied from the battery pack interface 235 to the motor 205. In response to the controller 245 receiving the activation signal from the trigger switch 215, the controller 245 activates the motor drive system 220 to provide power to the motor 205. The motor drive system 220 controls the amount of current available to the motor 205 and thereby controls the speed, torque, and power output of the motor 205. In some embodiments, the motor drive system 220 includes a plurality of switches, such as, for example, field-effect transistors (“FETs”), bipolar junction transistors, or other types of electrical switches. For instance, in some embodiments, the motor drive system 220 includes a switching network including a six-FET bridge that receives pulse-width modulated (“PWM”) signals from the controller 245 (or another gate driver) to drive the motor 205. In some embodiments, the motor drive system 220 includes more or less switches, a triac, motor brushes, and/or a commutator.

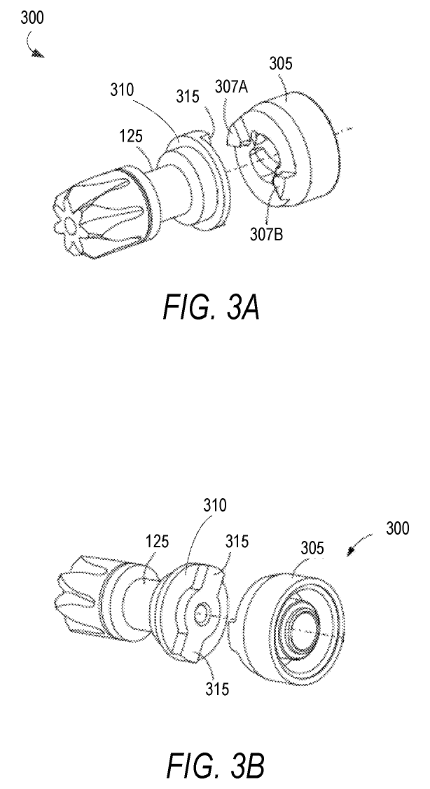

The sensors 225 are coupled to the controller 245 and communicate to the controller 245 various signals indicative of different parameters of the impact tool 100 and/or the motor 205. In the embodiment shown, the sensors 225 include Hall effect sensor(s) 225A, current sensor(s) 225B, impact sensor(s) 225C, strain sensor(s) 225D, one or more voltage sensors, one or more temperature sensors, and one or more torque sensors, one or more temperature sensors, etc. Each Hall effect sensor 225A outputs motor feedback information to the controller 245, such as an indication (e.g., a pulse) when a magnet of the motor’s rotor rotates across the face of that Hall effect sensor. Based on the motor feedback information from the Hall effect sensors 225A, the controller 245 can determine the position, velocity, and/or acceleration of the rotor. The electronic processor 255 may detect that the impact tool 100 is in operation based on depression of the trigger 130 or output signals from Hall effect sensors indicating that the motor 205 is rotating. The electronic processor 255 may also detect impact events using the impact sensors 225C. The impact sensors 225C can include a hammer translation sensor (“HTS”), an anvil rotation sensor (ARS”), a current measurement (e.g., battery current, motor current, or the like), a motor voltage, oscillation patterns of the impact tool 100 as measured by a sensor, etc. In some embodiments, the impact sensors include one or more inductive sensors, one or more Hall effect sensors, etc. In some embodiments, impact events can be detected using sensor threshold parameters, machine learning algorithms, a 1-dimentional Kalman filter, etc. The strain sensors 225D may include the various anvil strain gauges described herein and any other sensor configured to detect a strain or torque experienced by the anvil 310 of an impact mechanism 300 (see FIG. 3A) of the impact tool 100.

In response to the motor feedback information and the signals from the trigger switch 215, the controller 245 transmits control signals to control a motor drive system 220 to drive the motor 205. For instance, by selectively enabling and disabling the FETs of a switching network, power received via the battery pack interface 235 is selectively applied to stator coils of the motor 205, or to the motor brushes, to cause rotation of its rotor. The motor feedback information is used by the controller 245 to ensure proper timing of control signals to the motor drive system 220 and, in some instances, to provide closed-loop feedback to control the speed or torque of the motor 205 to be at a desired level.

As will be described in greater detail below, a wireless power and data transfer circuit 227 is configured to wirelessly power/excite sensing elements affixed to the anvil 310, embedded in the anvil 310, or associated with the anvil 310. The wireless power and data transfer circuit 227 includes a power transfer circuit 227A configured to transmit power wirelessly to anvil strain sensing elements (e.g., via a capacitive coupling, via an inductive coupling, near-field communication [“NFC”] couplings, etc.). In the embodiment shown, The wireless power and data transfer circuit 227 also includes a data transfer circuit 227B configured to transmit and/or receive data wirelessly to/from wireless powered sensing elements affixed to the anvil 310, embedded in the anvil 310, or associated with the anvil 310 (e.g., via a capacitive coupling, via an inductive coupling, via an NFC coupling, etc.). In some embodiments, the power transfer circuit 227A and data transfer circuit 227B are associated with a single wireless transmitter/receiver (e.g., antenna, coil, etc.). In such embodiments, the power transfer circuit 227A and/or data transfer circuit 227B are configured to superimpose communication signals on a carrier signal through amplitude modulation (“AM”) or frequency modulation (“FM”). In other embodiments the power transfer circuit 227A and the data transfer circuit 227B may be associated with separate wireless transmitters/receivers, and may disposed in separate portions of the impact tool 100 or at separate locations in or on the impact tool 100.

The indicators 230 are also coupled to the controller 245 and receive control signals from the controller 245 to turn on and off or otherwise convey information based on different states of the impact tool 100. The indicators 230 include, for example, one or more light-emitting diodes (“LED”) or a display screen. The indicators 230 can be configured to display conditions of, or information associated with, the impact tool 100. For example, the indicators 230 are configured to indicate measured electrical characteristics of the impact tool 100, the status of the impact tool 100, the mode of the power tool, etc. In some embodiments, the indicators 230 are configured to indicate when the impact tool 100 achieves a predetermined anvil torque or experiences a predetermined anvil strain. The indicators 230 may also include elements to convey information to a user through audible or tactile outputs.

As described above, the controller 245 is electrically and/or communicatively connected to a variety of modules or components of the impact tool 100. In some embodiments, the controller 245 includes a plurality of electrical and electronic components that provide power, operational control, and protection to the components and modules within the controller 245 and/or impact tool 100. For example, the controller 245 includes, among other things, a processing unit 255 (e.g., a microprocessor, a microcontroller, an electronic controller, an electronic processor, or another suitable programmable device), a memory 260, input units 265, and output units 270. The processing unit 255 (herein, electronic processor 255) includes, among other things, a control unit 255A, an arithmetic logic unit (“ALU”) 255B, and a plurality of registers 255C (shown as a group of registers in FIG. 2). In some embodiments, the controller 245 is implemented partially or entirely on a semiconductor (e.g., a field-programmable gate array [“FPGA”] semiconductor) chip, such as a chip developed through a register transfer level (“RTL”) design process. The electronic processor 255, the memory 260, and the input units 265 and output units 270 are electronically and communicatively connected to each other via one or more busses, such as common bus 275.

The memory 260 is a non-transitory computer readable medium and includes, for example, a program storage area 260A and a data storage area 260B. The program storage area 260A and the data storage area 260B can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The electronic processor 255 is connected to the memory 260 and executes software instructions that are capable of being stored in a RAM of the memory 260 (e.g., during execution), a ROM of the memory 260 (e.g., on a generally permanent basis), or another non-transitory computer readable medium such as another memory or a disc. Software included in the implementation of the impact tool 100 can be stored in the memory 260 of the controller 245. The software includes, for example, firmware, one or more applications, program data, filters, rules, one or more program modules, and other executable instructions.

The controller 245 is configured to retrieve from memory and execute, among other things, instructions related to the control processes and methods described herein. The controller 245 is also configured to store power tool information on the memory 260 including operational data, information identifying the type of tool, a unique identifier for the particular tool, and other information relevant to operating or maintaining the impact tool 100. The tool usage information, such as current levels (e.g., motor current level), motor voltage, motor torque, anvil strain, anvil torque, motor speed, motor acceleration, motor direction, anvil torque, and timing and number of impacts may be captured or inferred from data output by the sensors 225. Such power tool information may then be stored in the memory 260 and/or accessed by a user with an external device. In other embodiments, the controller 245 includes additional, fewer, or different components.

The wireless communication controller 250 is coupled to the controller 245 and includes a radio transceiver and antenna, and in some embodiments may include a memory, an electronic processor, and input/output elements similar but independent from those previously described with respect to the controller 245. The radio transceiver and antenna operate together to send and receive wireless messages to and from the external device (e.g., a user device such as a smart phone, tablet, or computer). In some embodiments, the wireless communication controller 250 is configured to receive parameters for operation of the power tool (e.g., a torque/speed demand curve) from the external device, and the controller is configured to control the power tool (e.g., the motor) based on the parameters. In some embodiments, the wireless communication controller 250 is a Bluetooth® controller. In other embodiments, the wireless communication controller 250 communicates using other protocols (e.g., Wi-Fi, cellular protocols, a proprietary protocol, etc.) over a different type of wireless network. For example, the wireless communication controller 250 may be configured to communicate via Wi-Fi through a wide area network such as the Internet or a local area network, or to communicate through a piconet (e.g., using infrared or NFC communications). The communication via the wireless communication controller 250 may be encrypted to protect the data exchanged between the impact tool 100 and an external device/network from third parties.

FIGS. 3A and 3B show an example impact mechanism 300 configured to be used in an impact tool (e.g., impact tool 100). Based on the design of the impact mechanism 300 of the impact tool 100, the motor 205 rotates at least a predetermined number of degrees between impacts (e.g., 180 degrees for the impact mechanism 300). The impact mechanism 300 includes a hammer 305 with outwardly extending lugs 307A, 307B and an anvil 310 with outwardly extending lugs 315. The anvil 310 is coupled to the drive device 125. In some embodiments, the drive device 125 includes a gearbox output for interfacing with a gearbox to drive another output shaft. In some embodiments, the hammer 305 is directly driven by the motor 205. FIGS. 3A and 3B illustrate a helical bevel gearbox output. However, other types of gearbox outputs may be used, such as a straight bevel, a spiral bevel, or the like. In some embodiments, the gearbox output is omitted and the drive device 125 directly interfaces with a workpiece. For example, the drive device 125 may be a socket as shown in FIG. 2, a chuck, or some other suitable type of workpiece interface. During operation, impacting occurs when the anvil 310 encounters a certain amount of resistance (e.g., when driving a fastener into a workpiece). When this resistance is met, the hammer 305 continues to rotate. A cam groove on a cam guiding the movement of the hammer 305 in the axial direction causes the hammer 305 to disengage the anvil 310 by axially retreating. While axially retreating, the hammer 305 compresses a spring coupled to the back-side of the hammer 305. Once the hammer 305 has axially retreated sufficiently to disengage the anvil 310, the hammer 305 advances rotationally again while the spring drives hammer 305 downward to once again engage (i.e., impact) the anvil 310. In the embodiment shown, when the impact mechanism 300 is operated, the hammer lugs 307A, 307B impact the anvil lugs 315, for example, every 180 degrees. Accordingly, when the impact tool 100 is impacting, the hammer 305 rotates 180 degrees without the anvil 310, impacts the anvil 310, and then rotates with the anvil 310 a certain amount before repeating this process. Each time the hammer lugs 307A, 307B impact the anvil lugs 315, a torque is applied to the anvil 310 by the hammer 305. If torque is applied to the anvil 310 by the hammer 305 while the anvil 310 is encountering resistance (e.g., when driving a fastener into a workpiece) the anvil 310 experiences a strain that may be measured by sensors (e.g., strain sensors 225D) to measure or determine a precise torque experienced by the anvil.

The controller 245 may be configured to determine an amount of torque applied to the anvil 310 with each impact. As will be described in further detail below, the strain sensors 225D are configured to sense an amount of strain experienced by the anvil 310 in response to be impacted by the hammer 305, and to produce a signal representative of this sensed amount of strain. The strain experience by the anvil 310 may be affected by the material that the anvil is made of. For example, an anvil 310 constructed from an alloyed metal may experience more or less strain for a given applied torque than an anvil 310 constructed from iron. The controller 245 may then use this signal from the strain sensor 225D to determine the amount of torque applied to the anvil 310 by the hammer 305.

The controller 245 may also be configured to determine how far the hammer 305 and the anvil 310 rotated together by monitoring the angle of rotation of the shaft of the motor 205 between impacts using one or more of the Hall effect sensors 225A or by monitoring the anvil position using the anvil position sensor. For example, when the impact tool 100 is driving an anchor into a softer joint, the hammer 305 may rotate 225 degrees between impacts. In this example of 225 degrees, 45 degrees of the rotation includes hammer 305 and anvil 310 engaged with each other and 180 degrees includes just the hammer 305 rotating before the hammer lugs 307A, 307B impact the anvil 310 again. Although two hammer lugs 307A, 307B configured to impact the anvil lugs 315 every 180 degrees are shown, more than two hammer lugs 307A, 307B may be used, which would change the degrees of separation (e.g., three hammer lugs that impact the anvil lugs 315 every 30 degrees), according to various embodiments.

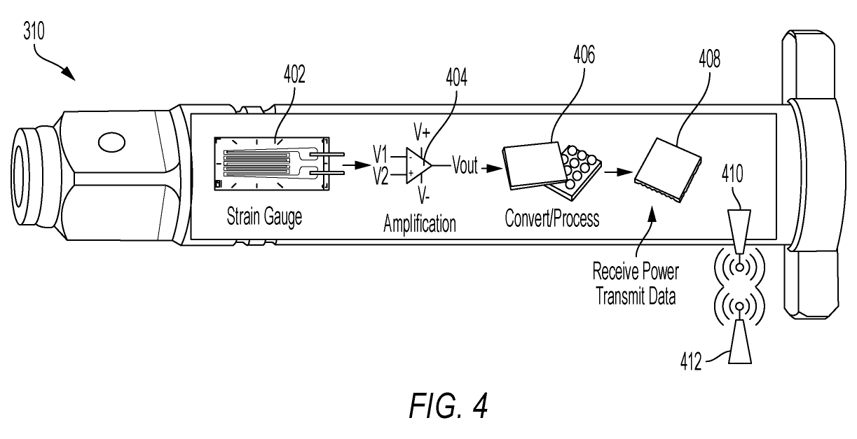

FIG. 4 illustrates the anvil 310 including a strain gauge 402, an amplifier 404, an analog-to-digital converter (“ADC”) 406, and a wireless power and data transfer circuit 408. In some embodiments, the ADC 406 includes a local processor (e.g., a microcontroller [“MCU”]). The amplifier 404 may be configured with a predetermined gain and offset to produce the amplified signal within a predetermined band (e.g., a narrow band). For example, the ADC 406 may be configured to accept amplified signals between 0.0V-3.3V and the strain gauge may be configured to output +/-10mV relative to +/-1000ft-lb of torque, while the amplifier 404 may be configured with a gain of 165V/V and an offset of 1.65V. In this example, the ADC 406 may be configured to convert the amplified signal into a digital signal, such as by outputting a digital signal representing -1000ft-lb of torque in response to receiving an amplified signal of -3.3V, a digital signal representing 0ft-lb of torque in response to receiving an amplified signal of 0V, and a digital signal representing 1000ft-lb of torque in response to an amplified signal of 3.3V. Continuing with this example, the ADC 406 may be configured to have a resolution of +/-50mV, resulting in a digital signal accuracy of +/-30ft-lb. In another example, if only forward anvil torques from, for example, 500ft-lb to 1000ft-lb are to be sensed, the amplifier 404 may be configured with a gain of 660V/V an an offset of -3.3V such that the ADC outputs a digital signal representing 500ft-lb of torque in response to an amplified signal of 0V, and outputs a digital signal representing 1000ft-lb of torque in response to an amplified signal of 3.3V. Continuing with this example, an ADC 406 having a resolution of +/-50mV accordingly has an accuracy of +/- 7.5ft-lb.

The amplifier 404 may also be selected to have a particular robustness (e.g., an ability to resist wear and tear or an ability to retain calibration). For example, the amplifier 404 may be selected to have automotive grade robustness. The amplifier 404 may be selected to have a particular size and configured to have a particular temperature dependence (e.g., a tendency of a sensitivity of the strain gauge 402 to change with temperature). For example, the amplifier 404 may be configured to have a temperature dependency of < 0.5% at temperatures ranging from -20C to 120C. The amplifier 404 may also be selected to have a particular linearity (e.g., a tendency of the sensitivity of the amplifier 404 to change over a range of input). For example, the amplifier 404 may be configured to have linearity of < 0.25% over full scale. In some embodiments, the strain gauge 402 and the amplifier 404 are packaged together as a single integrated circuit or unit (e.g., within a single housing). In some embodiments, the strain gauge 402, the amplifier 404, and the ADC 406 are packaged together as a single integrated circuit or unit (e.g., within a single housing). In some embodiments, the strain gauge 402, the amplifier 404, the ADC, and the wireless power and data transfer circuit 408 are packaged together as a single integrated circuit or unit (e.g., within a single housing). In some embodiments, the amplifier 404, the ADC 406, and/or the wireless power and data transfer circuit 408 are packaged together as a single integrated circuit or unit (e.g., within a single housing).

In the embodiment shown, the strain gauge 402 is affixed (e.g., adhered) to the anvil 310. The strain gauge 402 includes a piece of material having a resistance that varies as a function of how much the strain gauge 402 gets stretched or compressed. When the anvil 310 is impacted by the hammer 305, the anvil 310 is stretched and compressed as torque is applied. The strain gauge 402, being securely affixed to the anvil 310, is also compressed/stretched as a result of the impact to the anvil 310. For example, the strain gauge 402 may include several tracks of copper, gold, or another metal or alloy forming a resistor configured to stretch/compress when the anvil 310 is impacted. The tracks of the strain gauge may get longer, shorter, skinnier, wider, etc., as the anvil 310 experiences strain due to torsion causing the resistance of the strain gauge 402 to increase or decrease proportionally.

The amplifier 404 is also securely affixed to the anvil 310 and is connected to the ADC 406. In the embodiment shown, the ADC 406 includes a microcontroller (“MCU”) or another processing device. A wireless power and data transfer circuit 408 is connected to an output of the ADC 406 and may include an NFC chip configured to receive power via an antenna 410 and to transmit and/or receive data via the antenna 410.

An antenna 412 of the impact tool 100 (e.g., positioned within the housing of the impact tool 100) is configured to wirelessly transmit a power signal (e.g., an electromagnetic signal) to the wireless power and data transfer circuit 408. The wireless power and data transfer circuit 408 is configured to convert the power signal to electrical power (e.g., locally on the anvil 310). In this way, the wireless power and data transfer circuit 408 is configured to power the strain gauge 402, the amplifier 404, and the ADC 406. The wireless power and data transfer circuit 408 is also configured to wirelessly transmit data signals and sensor signals (e.g., an anvil strain sensed by the strain gauge 402, an anvil torque sensed by the strain gauge 402, a torque sensed or determined based on a torque sensor, etc.) to the impact tool 100. The controller 245 may analyze and/or process this data (e.g., by converting a sensed anvil strain to an anvil torque, by converting the anvil torque to an applied joint torque, etc.) to determine when to stop the motor 205, when to reduce motor power to hit a predetermined, desired anvil torque, etc. As will be described in greater detail below, in some embodiments, antenna 410 and antenna 412 may be near field communications (“NFC”) antennas, plates or foils in a wireless capacitive coupling, coils in an inductive coupling, or some other type of wireless communication.

In some embodiments, the strain gauge 402 is configured to draw approximately 15milli-Watts (“mW”)-20mW of power and includes approximately 200Ω-400Ω traces/wires configured to be excited to 2-3 Volts (“V”). The amplifier 404 may be configured to draw approximately 15mW-20mW. The ADC 406 may be configured to draw approximately 50mW-125mW. The wireless power and data transfer circuit 408 may be configured to consume approximately 75mW-125mW of power.

In some embodiments, a circuit board including the amplifier 404 and the ADC 406 is fixed within an internal slice/slot/notch of the anvil 310. The circuit board may be mounted to the anvil via a potting compound, such as an epoxy-based compound, a silicone-based compound, a urethane-based compound, a polyacrylate-compound, etc. In some embodiments, the circuit board and/or the antenna 410 is/are flexible and configured to wrap partially or fully around the circumference of the anvil 310. In some embodiments, the strain gauge 402 is selected/sized to be small enough so that one wavelength of natural frequency of the shaft of the anvil 310 can be captured. In some embodiments, an adhesive is used to affix the strain gauge 402 to the anvil 310. In such embodiments, the adhesive is selected to be applied thin enough and with high enough modulus of elasticity to transfer anvil strain appropriately to the strain gauge 402 (e.g., in a 1-to-1 transfer). In some embodiments the strain gauge 402 is selected to have a material that exhibits desirable temperature stability, and is sized to not fatigue over time or to be accurate even when high torques are applied to the anvil 310. The material of the strain gauge 402 may also be selected so that accuracy of the output of the strain gauge 402 is better within a narrow torque band of desired capability (as described above). In some embodiments, a silicon based strain gauge uses P and N dopants to form a silicon semiconductor that has a changing resistance as a function of strain (e.g., comparable to a foil gauge). Additionally, the strain gauge 402 may be selected to have a particular sensitivity (e.g., a particular change in resistance for a given change in length), a particular robustness (e.g., an ability to resist wear and tear or an ability to retain calibration), a particular size, a particular temperature dependence (e.g., a tendency of a sensitivity of the strain gauge 402 to change with temperature), or a particular linearity (e.g., a tendency of the sensitivity of the strain gauge 402 to change over a sensing range). In some embodiments, the strain gauge 402 is a silicon based MEMS (Micro Electromechanical System) structure having a piezoresistive design. In other embodiments, the strain gauge is a capacitive strain sensor using a MEMS structure.

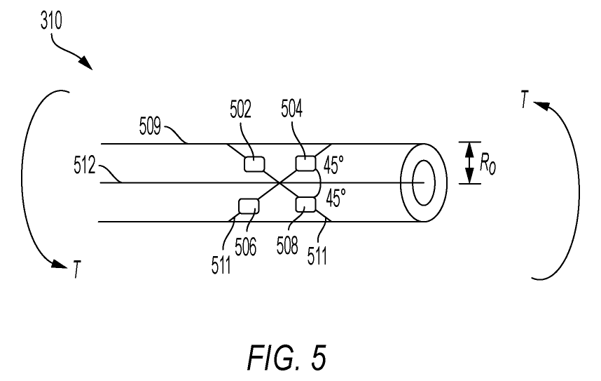

FIG. 5 illustrates the anvil 310 equipped with four strain gauges 502, 504, 506, 508 (e.g., replacing the strain gauge 402 in FIG. 4). In the embodiment shown, the strain gauges 502, 504, 506, 508, are positioned on the surface 509 of the anvil 310 (e.g., the surface 509 of the shaft of the anvil 310) at a 90° angle from each other (i.e., each strain gauge is separately placed at 45° from the center axis 512 of the anvil). The wireless power and data transfer circuit 408 is configured to wirelessly transmit the measurements of the strain gauges 502, 504, 506, 508 (e.g., sensed anvil strain, sensed anvil torque, etc.) to the impact tool 100. The controller 245 is configured to combine the signals from the strain gauges 502, 504, 506, 508 to determine an isolated torsional strain amount where the axial forces or bending forces sensed by the strain gauges 502, 504, 506, 508 cancel out due to the balanced positioning of the strain gauges 502, 504, 506, 508. The controller 245 may be configured to use the determined torsional strain amount to determine when to stop the motor 205, to reduce motor power to hit a predetermined, desired anvil torque, etc.

In the embodiment shown, the strain gauges are fixed to the anvil 310 over tracks 511 which give the anvil a non-uniform surface and increase the strain in the surface of the anvil 310, making the sensed anvil strain due to torsion more pronounced. Although four strain gauges are shown in FIG. 5, the anvil 310 may include 2, 4, 6, etc., strain gauges placed on the shaft of the anvil 310 at a 90° angle from each other and 45° from the center axis 512 of the anvil (or 180° radially from each pair). In some embodiments, only a single strain gauge (e.g., strain gauge 502) or an odd number of strain gauges are mounted to the anvil 310.

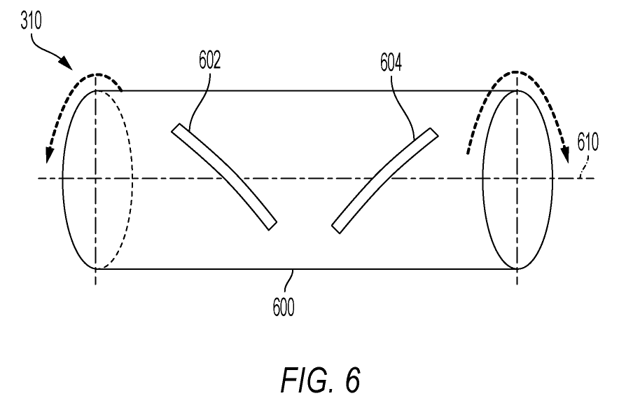

FIG. 6 illustrates the anvil 310 including an arrangement of two strain gauges 602, 604 (e.g., replacing the strain gauge 402 in FIG. 4). In the embodiment shown, the strain gauges 602, 604 are positioned on a surface 600 of the anvil 310 at a 90° angle from each other. The strain gauges 602, 604 are also positioned to be centrally aligned along the center axis 610 of the anvil 310. As with the embodiment shown in FIG. 5, the placement of the strain gauges 602, 604 is configured to allow the controller 245 to combine signals produced by the strain gauges 602, 604 and thereby cancel out axial or bending forces that stretch the strain gauges 602, 604. In the embodiment shown, the central alignment of the strain gauges 602, 604 and the V-shaped orientation of the strain gauges 602, 604 also helps to cancel out axial and bending forces experienced by the strain gauges 602, 604. The wireless power and data transfer circuit 408 is configured to transmit the measurements of the strain gauges 602, 604 (e.g., sensed anvil strain, sensed anvil torque, etc.) to the impact tool 100 wirelessly. The controller 245 is configured to combine the signals from the strain gauges 602, 604 to determine an isolated torsional strain amount where the axial forces or bending forces sensed by the strain gauges 602, 604 cancel out due to the balanced positioning of the strain gauges 602, 604. The controller 245 may be configured to use the determined torsional strain amount determine when to stop the motor 205, to reduce motor power to hit a predetermined, desired anvil torque, etc.

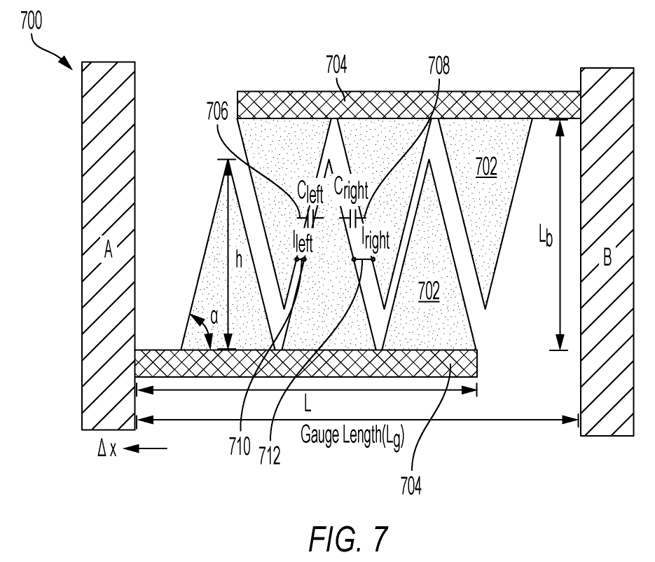

FIG. 7 illustrates a capacitive strain gauge 700 that may be used to measure a strain experienced by the anvil 310 (e.g., replacing the strain gauge 402 in FIG. 4). A plurality of interleaved teeth 702 are mounted on two cantilever beams 704 having length L and spaced apart from one another by length L_{b}. The interleaved teeth 702 are of uniform height h and are configured to act as capacitor plates when energized (e.g., by the wireless power and data transfer circuit 408). In the embodiment shown, when strain is applied to the strain gauge 700, the interleaved teeth 702 move with respect to one another, changing the spacing of the interleaved teeth 702. The movement of the interleaved teeth 702 with respect to one another changes a plurality of capacitances 706, 708 and inductances 710, 712 between the interleaved teeth 702. The strain gauge 700 generates an output signal indicative of the strain experienced by the strain gauge 700 and corresponding to the changes in the capacitances 706, 708 and inductances 710, 712 in response to the strain.

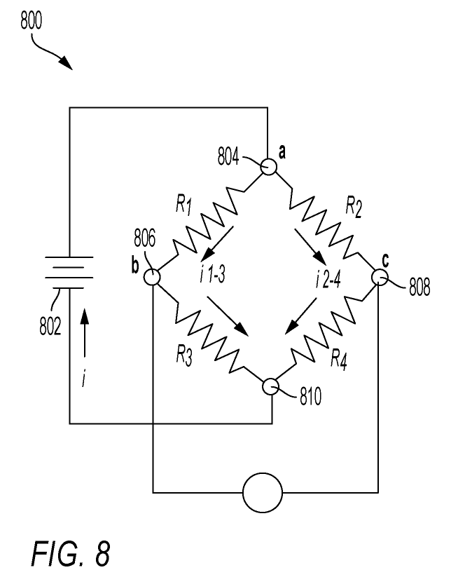

FIG. 8 illustrates a Wheatstone bridge circuit 800 for use with two or more strain gauges (e.g., as shown in FIGS. 4-6). In some embodiments, a plurality of strain gauges 502, 504, 506, 508 are affixed to the anvil 310 and are each configured to produce a signal corresponding to a strain experienced by the anvil. The Wheatstone bridge circuit 800 may be connected to a power source 802 (e.g., wireless power and data transfer circuit 408) and configured to receive signals from each of the strain gauges 502, 504, 506, 508 at a plurality of nodes 804, 806, 808, 810. The Wheatstone bridge circuit 800 may be configured to generate a differential signal based on the signals received at the nodes 804, 806, 808, 810. This differential signal represents an average of strain measurements collected via the strain gauges 502, 504, 506, 508. Although not shown, one or more operational amplifiers (e.g., amplifier 404) may be configured to amplify the differential signal produced across the Wheatstone bridge circuit 800 for processing by the ADC 406.

In some embodiments, the ADC 406 is configured to convert the amplified signal into a digital signal that can be wirelessly transmitted (e.g., via antenna 410) back to the controller 245 (e.g., having been first received at antenna 412). In the embodiments shown, the ADC 406 is configured to sample the output of the amplifier 404 at high rates (e.g., at two times the bandwidth of the strain pulses sensed by the strain gauge 502, or up to 100 kilo-samples per second [“kS/s”] or more) and to derive a torque applied to the anvil 310 on each impact. The ADC 406 may be configured to process this data locally (e.g., on the anvil 310) to also derive, for example, the peak torque, a width of a torque pulse sensed by the strain gauge 402, an area under a torque pulse, and/or a shape of the torque pulse. This local processing may produce a 99.5% reduction in data communicated to the controller 245. For example, if the raw data is collected in 14bit chunks at 100 kS/s, then 1,400,000 bits are collected per second, but if only 5 32-bit key data metrics are produced by the ADC 406 per impact of the anvil 310 at a 50Hz impacting rate, then only 8000 bits need to be transmitted to the controller 245, representing a 99.5% reduction in data rates required for wireless data transmission from antenna 410 to antenna 412. The controller 245 may be configured to use the torque applied to the anvil, the peak torque, the width of a torque pulse, the area under the torque pulse, and/or the shape of the torque pulse determined by the ADC to determine when to stop the motor 205, to reduce motor power to hit a predetermined, desired anvil torque, etc.

In the embodiments shown, the wireless power and data transfer circuit 408 is an NFC circuit equipped with a power and data transmission and reception coil configured to transmit data at a rate of 200 kilo-bytes per second (“kbps”)-1000kbps (e.g., 300kbps-600kbps). The transmission coil is configured to transfer power and data wirelessly through, for example, inductive coupling (e.g., in the same manner as an air core transformer) at 5 mega-Hertz (“MHz”)-20MHz. The frequency of the power transmission signal may be high, and a modulation scheme can be used to transfer the data along with the power transmission signal. The power transmission signal is then received and demodulated at the receiver (e.g., similar to radio waves).

In some embodiments, a capacitive, inductive, or light based coupling is used to wirelessly transmit power and data between antenna 410 and antenna 412. In such embodiments, the wireless communication protocol used may not be an NFC protocol. Although not shown, in some embodiments, power is transmitted from the impact tool 100 to the anvil 310 via a first antenna/link at a first frequency and data is wirelessly transmitted between the anvil 310 at a different frequency.

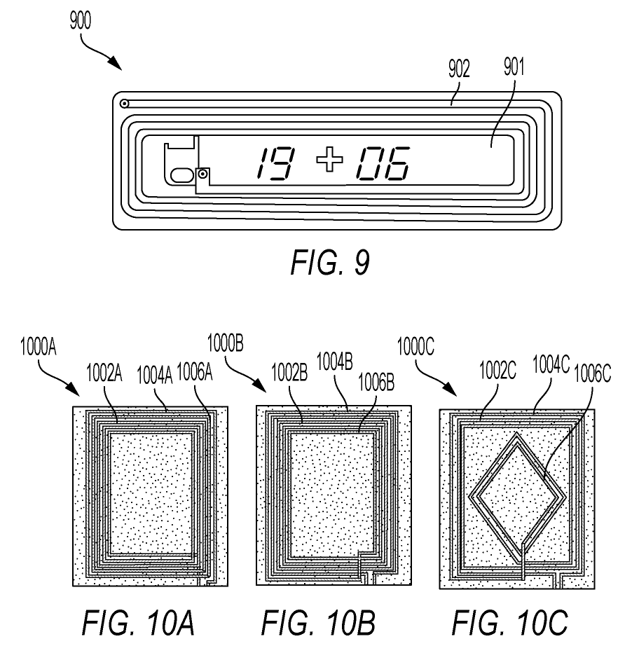

FIG. 9 illustrates an NFC antenna 900 which may correspond to antenna 410 and/or antenna 412. In the embodiment shown, the NFC antenna 900 is in the shape of an elongated rectangle and includes a flexible substrate 901 configured to be wrapped partially or fully around the circumference of the anvil 310, or positioned in the housing of the impact tool 100 adjacent to the anvil 310 (e.g., at least partially surrounding the anvil 310). The NFC antenna 900 includes loops of circuit traces 902 configured to be energized by a power source and to produce an electromagnetic field, or to have a current induced in them by an incident electromagnetic field. In some embodiments, the NFC antenna 900 is configured to correspond to or cover 180° of the circumference of the anvil 310 so that, at any point of a rotation of the anvil 310, the NFC antenna 900 is capable of communicating with the corresponding antenna (e.g., antenna 410 or antenna 412) as the anvil 310 rotates with respect to the antenna 412. In some embodiments, the NFC antenna 900 is configured to correspond to or cover up to 360° of the circumference of the anvil 310. FIGS. 10A, 10B, and 10C illustrate other NFC antennas 1000A, 1000B, 1000C that may correspond to antenna 410 or antenna 412. Each of the NFC antennas 1000A, 1000B, 1000C includes loops of circuit traces 1002A, 1002B, 1002C configured to be energized by a power source and to produce an electromagnetic field, or to have a current induced in them by an incident electromagnetic field. Each of the NFC antennas 1000A, 1000B, 1000C also include a top trace 1004A, 1004B, 1004C, disposed on a top face of a substrate of the antenna, and a bottom trace 1006A, 1006B, 1006C, disposed on a bottom face of a substrate of the antenna. In some embodiments, the bottom trace 1006A, 1006B, 1006C is used for receiving and transmitting wired power to and from the wireless power and data transfer circuit 408, and the top trace 1004A, 1004B, 1004C is used for transmitting and receiving electromagnetic fields. The antennas 1000A, 1000B, 1000B can similarly be formed on a flexible substrate that can be wrapped partially or fully around the circumference of the anvil 310.

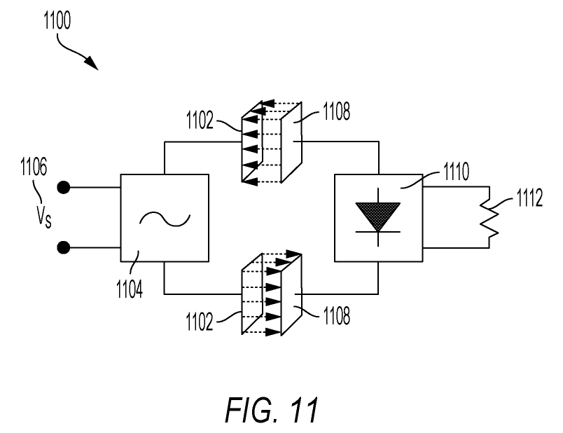

FIG. 11 illustrates a capacitive coupling circuit 1100 configured to transfer power wirelessly from the impact tool 100 to the anvil 310 (e.g., from antenna 412 to antenna 410), and to transfer data wirelessly between the impact tool 100 and the anvil 310 (e.g., to and/or from the anvil 310). In the embodiment shown, capacitive plates 1102 are energized by an alternating signal produced by an oscillator 1104 powered by a power source 1106 (e.g., battery pack 210) of the impact tool 100. The alternating energization of the capacitive plates 1102 in turn causes an alternating energization of capacitive plates 1108 positioned on the anvil 310, thereby producing an alternating power signal at the anvil 310. A rectifier 1110 rectifies the signal to approximate a DC power signal to power a load 1112 (e.g., the strain gauge 402, the amplifier 404, and the ADC 406). Although not shown, capacitive plates 1108 may be 2 solid plates or portions of foil (e.g., in the shape of rectangles) that wrap around the anvil 310. In this way, the capacitive plates 1108 can be configured to be energized via the capacitive plates 1102 wirelessly over the air, regardless of the rotational position of the anvil 310. In some embodiments, the capacitive plates 1102 and the capacitive plates 1108 are integrated into a flexible circuit board used to hold the processing circuitry (e.g., the ADC 406). The strain gauge 402, amplifier 404, ADC 406 may be configured to be powered wirelessly via the capacitive coupling circuit 1100. In some embodiments, the capacitive coupling circuit 1100 performs the wireless data transfer and wireless power transfer functions of the wireless power and data transfer circuit 408.

In some embodiments, a capacitive plate 1102 is configured to be used via a capacitive coupling as the anvil antenna (e.g., antenna 410) and is sized to wrap around, for example, a 15mm anvil shaft. The length of the capacitive plate 1102 may be sized to match the circumference of the anvil: pi*15mm = 47mm. The width of the capacitive plate may be roughly 5mm, thereby giving an area of A = 47*5 = 0.000235m² for the capacitive plate 1102. In such examples, the air gap between the capacitive plate 1102 and the capacitive plate 1108 may be 0.5mm (0.0005m). Assuming a permittivity of air of roughly 8.854pF/m, the total capacitance of one of the resulting over-air capacitors would be roughly: 8.854*0.235/0.0005 = 4.168pF. In some embodiments, the anvil shaft is 10mm-30mm, and the width of the capacitive plates is 3mm-10mm.

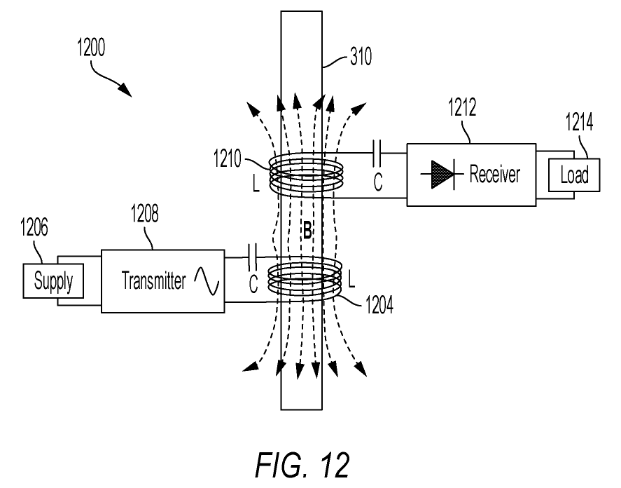

FIG. 12 illustrates an inductive coupling circuit 1200. In the embodiment shown, the metal of the shaft of the anvil 310 is used as the core of an inductive coupling configured for wireless power transfer from the impact tool 100 to the anvil 310. In the embodiment shown, a first wire 1204 is configured to wrap around the anvil 310. The first wire 1204 is connected to the impact tool 100 and configured to be energized by a power source 1206 (e.g., the battery pack 210) and transmitter 1208 of the impact tool 100. When the first wire 1204 is energized, it produces an electromagnetic field. A second wire 1210 is wrapped around the anvil 310 several times and is connected to a receiver 1212 embedded in or on the anvil 310. The second wire 1210 is configured to have a current induced in it by the electromagnetic field produced by the first wire 1204. In the embodiment shown, the receiver 1212 and a load 1214 are configured to be powered by the current induced in the second wire 1210. The strain gauge 402, amplifier 404, ADC 406 may be configured to be powered wirelessly via the inductive coupling circuit 1200. In some embodiments, the inductive circuit 1200 performs the wireless data transfer and wireless power transfer functions of the wireless power and data transfer circuit 408. In this particular application, an iron anvil may help improve the inductive coupling coefficient and power transfer efficiency.

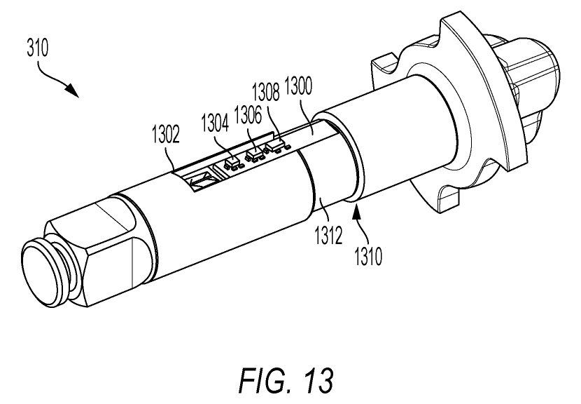

FIG. 13 illustrates a configuration of a wirelessly powered sensing circuit board 1300 and strain gauge 1302 affixed to an anvil 310. The circuit board 1300 includes an amplifier 1304, an ADC 1306, and a wireless power and data transfer circuit 1308. The strain gauge 1302, the amplifier 1304, the ADC 1306, and the wireless power and data transfer circuit 1308 correspond to the similar components described herein. The strain gauge 1302 and the circuit board 1300 are affixed to the anvil 310 (e.g., using a potting compound) within a channel 1310 defined in the surface of the anvil 310. In the embodiment shown, the circuit board 1300 includes extensions 1312 which are also positioned in the channel 1310 and configured to wrap partially or fully around the circumference of the anvil 310. The extensions 1312 may be flexible and may include conductive material (e.g., metal wire, etc.) configured to perform the functions of antenna 410. For example, the extensions 1312 may include circuit traces connected to wireless power and data transfer circuit 1308 and configured to have current induced therein by an incident electromagnetic field (e.g., produced by antenna 412), and/or to transmit an electromagnetic field when energized (e.g., by the wireless power and data transfer circuit 1308). Although the embodiment shown includes a circuit board 1300 including the amplifier 1304, the ADC 1306, and the wireless power and data transfer circuit 1308, in some embodiments, the amplifier 1304, ADC 1306, and wireless power and data transfer circuit 1308 are all included on a single unit (e.g., a single housing for a single integrated circuit), thereby improving circuit reliability and reducing cost and size.

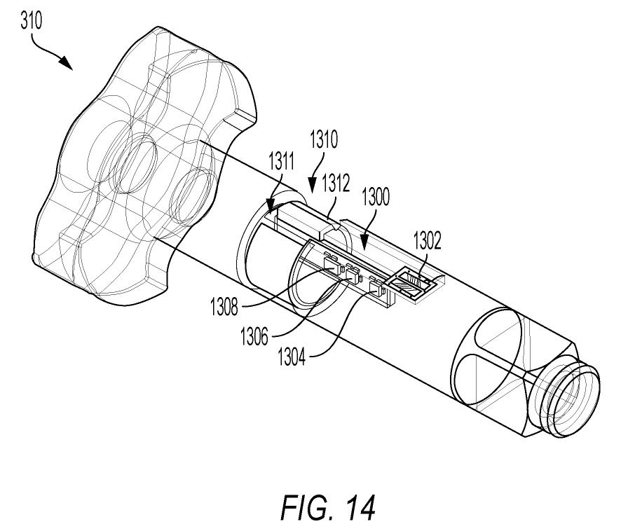

FIG. 14 illustrates a second configuration of a wirelessly powered sensing circuit board 1300 and strain gauge 1302 affixed to the anvil 310. The circuit board 1300 is mounted into a slot 1311 to reduce acceleration (shock) on the components of the circuit board 1300 by positioning the circuit board 1300 closer to a center of rotation of the anvil 310, resulting a reduced moment arm and acceleration of the circuit board 1300 when the anvil 310 is impacted by the hammer 305 during operation. The other components function as already described herein.

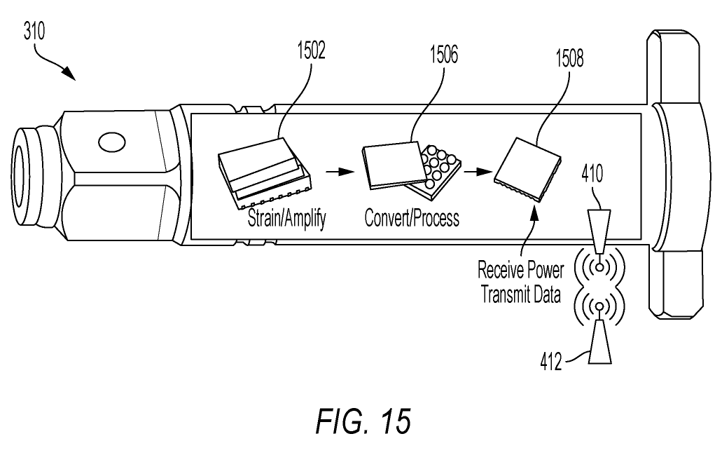

FIG. 15 illustrates an anvil 310 including a strain sensing and amplification integrated circuit 1502 connected to an ADC 1506. In the embodiment shown, the ADC 1506 includes an MCU. A wireless power and data transfer circuit 1508 is connected to an ADC 1506 and may include an NFC chip configured to receive power via an antenna 410 and to transmit and/or receive data via the antenna 410. A matching antenna 412 of the impact tool 100 (e.g., an antenna positioned in the housing of the impact tool 100) is configured to wirelessly transmit a power signal to the wireless power and data transfer circuit 1508. The wireless power and data transfer circuit 1508 is configured to receive the power signal via the antenna 410 and to convert the power signal to electrical power for powering the strain sensing and amplification integrated circuit 1502 and the ADC 1506. As described with respect to FIG. 4, the wireless power and data transfer circuit 1508 is also configured to transmit data and sensor signals (e.g., an anvil strain sensed by the strain sensing and amplification integrated circuit 1502, an anvil torque sensed by the strain sensing and amplification integrated circuit 1502, a torque sensed or determined based on a torque sensor, etc.) to the impact tool 100 wirelessly. The controller 245 may analyze and/or process this data (e.g., by converting a sensed anvil strain to an anvil torque, by converting the anvil torque to an applied joint torque, etc.) to determine when to stop the motor 205, to reduce motor power to hit a predetermined, desired anvil torque, etc.

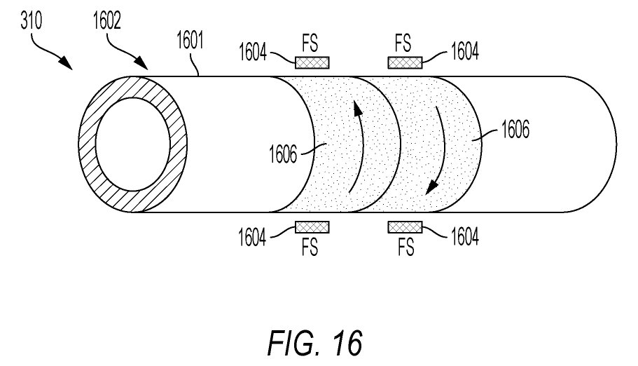

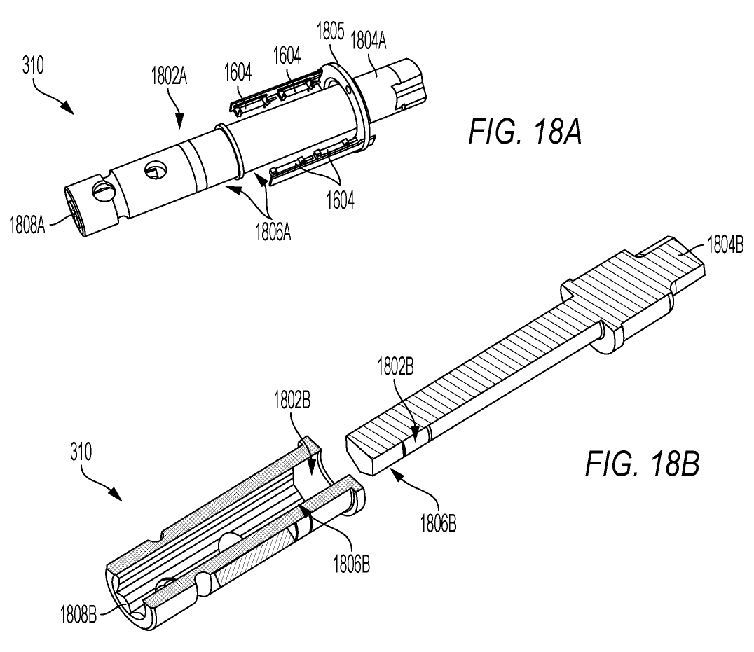

FIG. 16 illustrates the anvil 310 having a magnetized surface 1601 (e.g., a permanently magnetized surface) configured to be sensed via magnetometers 1604 in a sensor assembly 1805 (see FIG. 18A). In the embodiment shown, the shaft 1602 of the anvil 310 is magnetized at the surface 1601 with a unique pattern of magnetic fields 1606. As the anvil 310 experiences tortional strain (e.g., an instantaneous torsion due to being impacted by the hammer 305) the orientation of the magnetic fields 1606 skew. The shifts in the magnetic fields 1606 directly correlate to the torque experienced by the shaft 1602. Magnetometers 1604 (e.g., flux gate magnetometers) are configured to measure these magnetic field shifts. The magnetometers 1604 communicate the sensed shifts in the magnetic fields 1606 to the controller 245, and the controller 245 determines the torque applied to the anvil 310 based on the sensed shifts in the magnetic fields. Although not shown, in some embodiments, a socket reader of the power tool is configured to automatically identify a socket mechanically connected to the anvil 310 (e.g., by reading a barcode) and to automatically compensate for any change to magnetic properties of the anvil 310 caused by the connection of the socket to the anvil 310. Additionally, for this particular approach to sensing anvil torque, the material of the anvil 310 may be selected to be suited both for use in an anvil 310 of an impact power tool and for magnetization (e.g., permanent magnetization). In some embodiments, the shaft of the anvil 310 is hollow. In some embodiments the magnetometers 1604 output a 30k-50kHz wireless signal (e.g., an electromagnetic field), and sense changes in the wireless signal to detect a shift in the magnetic fields 1606 of the anvil 310.

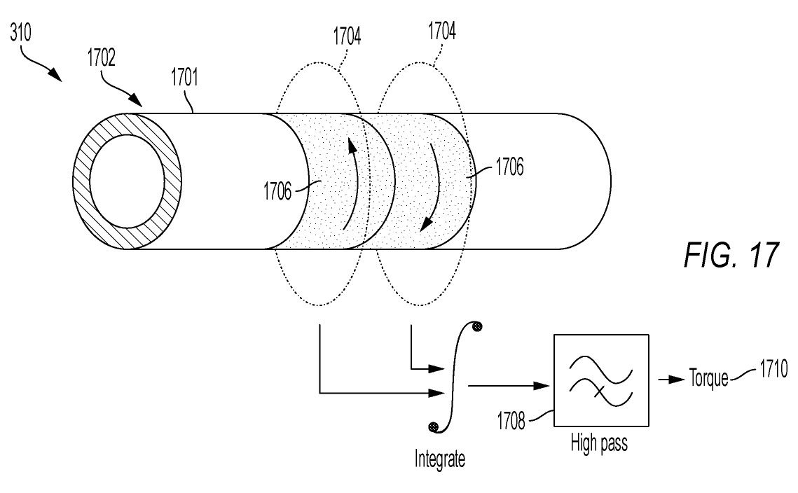

FIG. 17 illustrates the anvil 310 having a magnetized surface 1701 (e.g., a permanently magnetized surface) configured to be sensed via passive coils 1704. In the embodiment shown, the shaft 1702 of the anvil 310 is magnetized at the surface 1701 with a unique pattern of magnetic fields 1706. As the anvil 310 experiences tortional strain (e.g., an instantaneous torsion due to being impacted by the hammer 305) the orientation of the magnetic fields 1706 skew. The changes in the magnetic fields 1706 directly correlate to the torsional strain experienced by the shaft 1702 due to a torque being applied to the anvil 310. A rate of change in the magnetic fields induces a voltage (V=dΦ/dt) in the passive coils 1704 as a result of the change. The passive coils 1704 are positioned in the housing of the impact tool 100, and the controller 245 is configured to observe the voltages induced in the passive coils 1704 and determine the torque applied to the anvil 310 based on the induced voltages. In the embodiment shown, the voltages induced in the passive coils are integrated by the controller 245 and passed through a high pass filter 1708 to determine a peak torque 1710 experienced by the anvil 310.

In integrating the sensor output, the noise of the surrounding environment can rapidly cause the signal to degrade as the noise is repeatedly summed into a true signal. Therefore, a high pass filter 1708 is applied to the voltage signals produced by the passive coils 1704. Due to the function of the impact mechanism 300, the torque 1710 experienced by the anvil 310 upon impact is very fast, and the voltage produced in the passive coils 1704 is therefore also very fast. Consequently, the signal produced by the passive coils 1704 is also very short in duration (e.g., roughly < 200µs). The high pass filter 1708 may drive this type of signal to zero after integration, but is likely to retain near perfect accuracy with regard to the short impact pulses.

In some embodiments, a socket reader of the impact tool 100 may be configured to automatically identify a socket mechanically connected (e.g., as drive device 125) to the anvil 310 (e.g., by reading a barcode) and automatically compensate for any change to magnetic properties of the anvil 310 caused by the connection of the socket to the anvil 310. Additionally, the material of the anvil 310 may be selected to be suited to both use in an impact power tool and magnetization.

FIGS. 18A and 18B illustrate a two-part embodiment of the anvil 310. An insulating press bore 1802A, 1802B is configured to disrupt a magnetic circuit between a first portion 1804A, 1804B of the anvil shaft 1806A, 1806B used as a sensor element (e.g., as described with respect to FIGS. 16 and 17) and a second portion 1808A, 1808B of the anvil shaft 1806A, 1806B that connects to various user accessories (e.g., a socket, as described with respect to FIGS. 16 and 17). The first portion 1804A, 1804B of the anvil shaft 1806A, 1806B is press fit into the second portion 1808A, 1808B of the shaft of the anvil shaft 1806A, 1806B via the insulating press bore 1802A, 1802B. The insulating press bore 1802A, 1802B may be constructed of non-magnetizable material (e.g., non-ferromagnetic metal such as titanium, etc.) or non-conductive material (e.g., non-conductive ceramic, etc.), and is therefore configured to prevent the magnetization of the second portion 1808A, 1808B of the anvil shaft 1806A, 1806B when the first portion 1804A, 1804B of the anvil shaft 1806A, 1806B is magnetized. The illustrated two-piece anvil 310 including a non-ferromagnetic and/or a non-conductive anvil portion enables the us of a magnetized anvil shaft (e.g., see FIGS. 16 and 17). The non-ferromagnetic and/or non-conductive portions insulate the magnetic circuit of the sensor from the workpiece and accessories. In addition to preventing the second portion 1808A, 1808B from being magnetized, the insulating press bore 1802A, 1802B participates in transferring torque from the first portion 1804A, 1804B to the second portion 1808A, 1808B when the anvil 310 is impacted by the hammer 305. In the embodiment shown, the insulating press bore 1802A, 1802B extends around the entirety of an outer circumference of the first portion 1804A, 1804B, and also extends around the entirety of an inner circumference of the second portion 1808A, 1808B, and has a width of, for example, 0.5mm-4mm. However, in some embodiments, the press bore extends only partially around a circumference of the first portion 1804A, 1804B, or the second portion 1808A, 1808B.

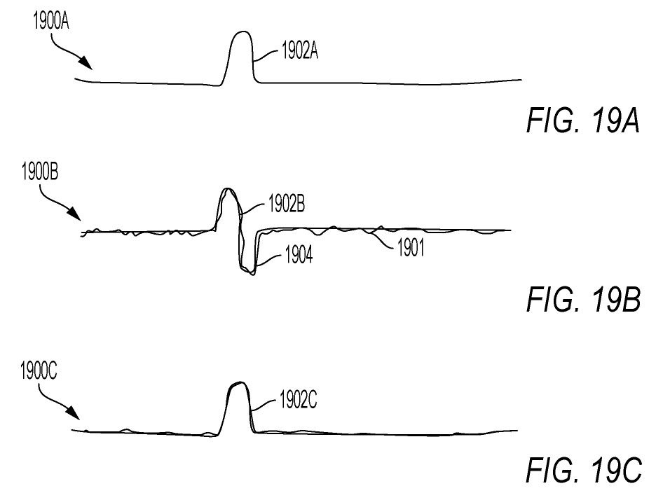

FIG. 19A illustrates a real torque 1900A experienced by the anvil 310 in response to being impacted by a hammer (e.g., hammer 305). The real torque 1900A includes a torque spike 1902A representing the actual torque experience by the anvil at the time at which the anvil is impacted by the hammer.

FIG. 19B illustrates voltage output 1900B from a magnetic sensor (e.g., magnetometers 1604, passive coils 1704, etc.) during an impact to an anvil 310 having a magnetized surface 1601, 1701. The voltage output 1900B includes noise 1901, a torque spike 1902B, and a corresponding torque valley 1904.

FIG. 19C illustrates a torque signal 1900C produced by filtering and integrating the voltage output 1900B from the magnetic sensor described with respect to FIG. 19B. The torque signal 1900C includes a torque spike 1902C and does not include noise 1901 or the torque valley 1904 as a result of filtering, and therefore approximates the real torque 1900A.

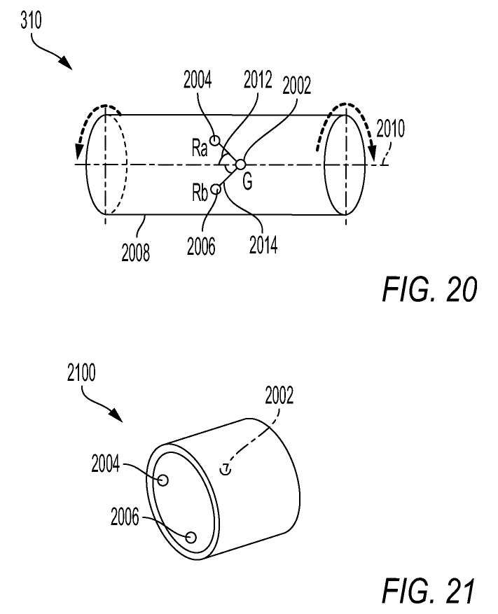

FIG. 20 illustrates the anvil 310 configured to be positioned adjacent to a transmitting coil 2002 and two receiving coils 2004, 2006 of an impact tool 100 as part of an anvil strain sensing system. The transmitting coil 2002 is configured to produce an electromagnetic field in response to being excited by an alternating current (e.g., a sine wave power signal produced via the controller 245). In operation, the transmitting coil 2002 is positioned adjacent the anvil shaft 2008 normal to the axis of rotation 2010 of the anvil shaft 2008. The two receiving coils 2004, 2006 are also positioned adjacent the anvil shaft 2008 equidistantly from the transmitting coil 2002. The two receiving coils 2004, 2006 are separated by opposite 45° angles 2012, 2014 with respect to the transmitting coil 2002 and are positioned normal to the axis of rotation 2010. In this way, though mounted on some other portion of the tool (e.g., the housing of the impact tool 100) the transmitting coil 2002 and the two receiving coils 2004, 2006 form a “triangle” of coils when projected onto the anvil shaft 2008. The 45° angles 2012, 2014 are along torsional angles of the anvil 310 and, as torque is applied to the anvil 310 (e.g., as a result of the hammer 305 impacting the anvil 310), the portion of the anvil shaft 2008 between the two receiving coils 2004, 2006 and the transmitting coil 2002 are evenly strained (e.g., in compression or tension depending on the direction, but in opposing magnitudes). For example, when the anvil 310 is impacted by the hammer 305, the portion of the anvil shaft 2008 between the transmitting coil 2002 and the receiving coil 2004 may be tensioned while the portion of the anvil shaft 2008 between transmitting coil 2002 and the receiving coil 2006 is compressed.

The transmitting coil 2002 and the receiving coil 2004 form a first transformer and the transmitting coil 2002 and the receiving coil 2006 form a second transformer when the transmitting coil 2002 is energized. As a torque is introduced to the anvil 310, voltages measurable at the first receiving coil 2004 and associated with the second receiving coil 2006 change due to the permeability of the anvil 310 changing from strain. Specifically, as the portion of the anvil shaft 2008 between the transmitting coil 2002 and the receiving coil 2004 experiences tension, the voltage on the receiving coil 2004 goes down because the mutual inductance of the transformer formed by between the transmitting coil 2002 and the receiving coil 2004 goes down. At the same time, as the portion of the anvil shaft 2008 between transmitting coil 2002 and receiving coil 2006 is compressed, the voltage on receiving coil 2006 goes up because the mutual inductance of the transformer formed by between the transmitting coil 2002 and the receiving coil 2006 goes up.

FIG. 21 illustrates a sensor assembly 2100 equipped with the transmitting coil 2002 and the two receiving coils 2004, 2006 configured to measure the changes in voltage on the two receiving coils 2004, 2006 as torque is applied to the anvil 310. The sensor assembly 2100 may be configured to communicate the sensed change in the voltage of the first receiving coil 2004 and the voltage sensed in the second receiving coil 2006 to the controller 245. The controller 245 may be configured to subtract the two voltage signals to produce a sine wave signal having an amplitude that is proportional to the torque applied to the anvil 310. The controller 245 may measure this amplitude and determine the torque applied to the anvil 310 based upon the measured amplitude. The controller 245 may also be configured to use the determined torque applied to the anvil 310 to determine when to stop the motor 205, to reduce motor power to hit a predetermined, desired anvil torque, etc.

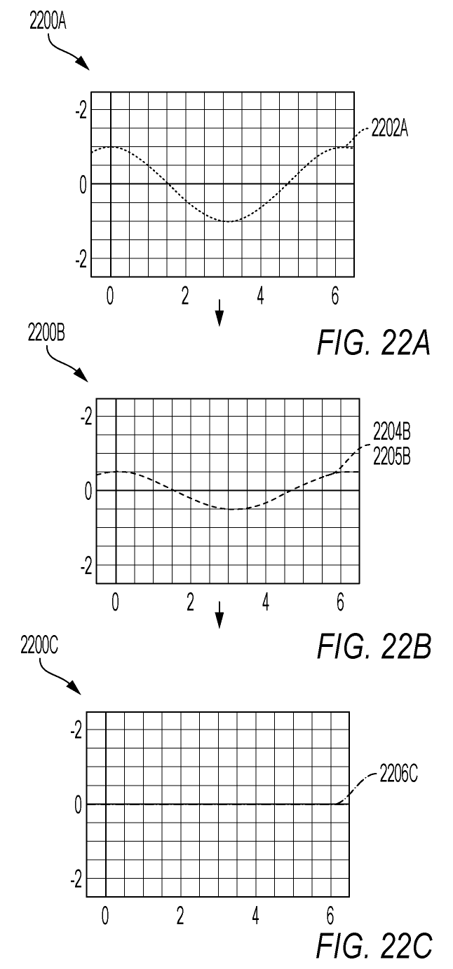

FIGS. 22A and 22B illustrate graphs 2200A, 2200B of voltage signals 2202A, 2204B, 2205B read by the sensor assembly 2100 when the transmitting coil 2002 and the two receiving coils 2004, 2006 are excited and no torque is applied to the anvil 310. The voltage signal 2202A is a sine wave voltage signal used (e.g., by the controller 245) to excite the transmitting coil 2002. The voltage signals 2204B, 2205B are the voltage signals read (e.g., by the controller 245) at the two receiving coils 2004, 2006 when they are excited by the electromagnetic waves produced by the transmitting coil 2002.

FIG. 22C illustrates a graph 2200C of a voltage signal 2206C produced (e.g., by the controller 245) when the voltage signals 2204B, 2205B measured at the two receiving coils 2004, 2006 are subtracted from one another. In the embodiment shown, the voltage signal 2206C has an amplitude of zero because no torque is being applied to the anvil 310.

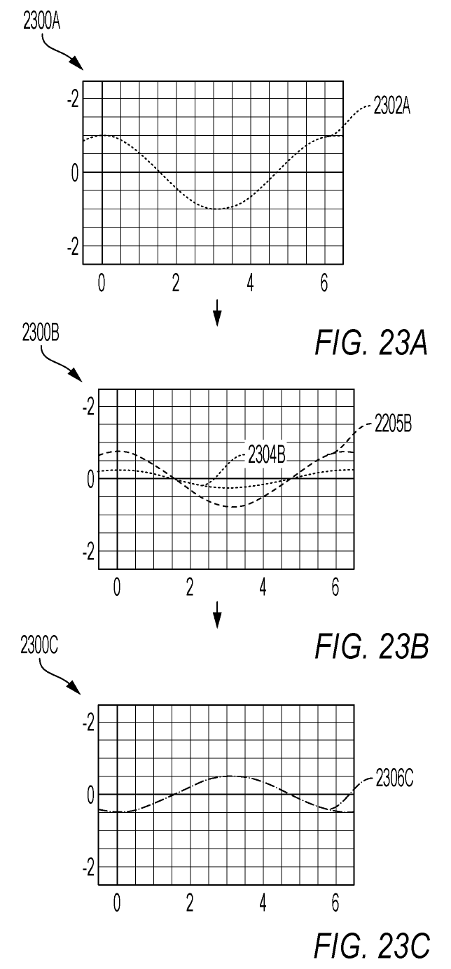

FIGS. 23A and 23B illustrate graphs 2300A, 2300B of voltage signals 2302A, 2304B, 2306C read by the sensor assembly 2100 when the transmitting coil 2002 and the two receiving coils 2004, 2006 are excited and a positive torque (e.g., 1Nm of torque) is applied to the anvil 310. The voltage signal 2302A is a sine wave voltage signal used (e.g., by the controller 245) to excite the transmitting coil 2002. The voltage signals 2304B, 2305B are the voltage signals read (e.g., by the controller 245) at the two receiving coils 2004, 2006 when they are excited by the electromagnetic waves produced by the transmitting coil 2002.

FIG. 23C illustrates a graph 2300C of a voltage signal 2306C produced (e.g., by the controller 245) when the voltage signals 2304B, 2305B measured at the two receiving coils 2004, 2006 are subtracted from one another. In the embodiment shown, the voltage signal 2306C has an amplitude of 0.25, which can be correlated to the positive torque is being applied to the anvil 310.

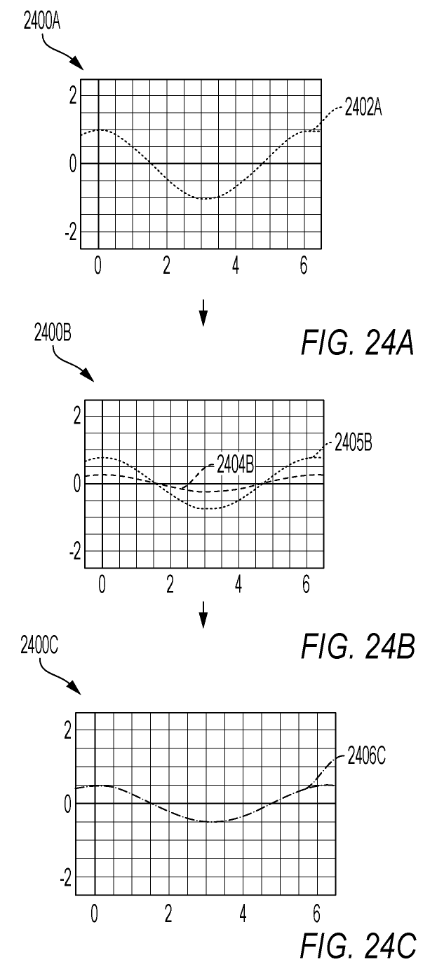

FIGS. 24A and 24B illustrate graphs 2400A, 2400B of voltage signals 2402A, 2404B read by the sensor assembly 2100 when the transmitting coil 2002 and the two receiving coils 2004, 2006 are excited and a negative torque (e.g., -1Nm of torque) is applied to the anvil 310. The voltage signal 2402A is a sine wave voltage signal used (e.g., by the controller 245) to excite the transmitting coil 2002. The voltage signals 2404B, 2405B are the voltage signals read (e.g., by the controller 245) at the two receiving coils 2004, 2006 when they are excited by the electromagnetic waves produced by the transmitting coil 2002.

FIG. 24C illustrates a graph 2400C of a voltage signal 2406C produced (e.g., by the controller 245) when the voltage signals 2404B, 2405B measured at the two receiving coils 2004, 2006 are subtracted from one another. In the embodiment shown, the voltage signal 2406C has an amplitude of 0.25, which can be correlated to the negative torque is being applied to the anvil 310.

In some embodiments, more than one transmitting coil is used, or more than two receiving coils are used. In some embodiments, the receiving coils (e.g., receiving coils 2004, 2006) are positioned at a different angle from the transmitting coil 2002. In some embodiments, the size and, turn counts of the transmitting coil 2002 differs from the size and turn counts of the two receiving coils 2004, 2006. In some embodiments the controller causes the transmitting coil 2002 to be excited by a 70k-110kHz signal (e.g., via an oscillator) and sensors (e.g., sensors 225) sample the voltage signals on the two receiving coils at 1k-10kS/s.

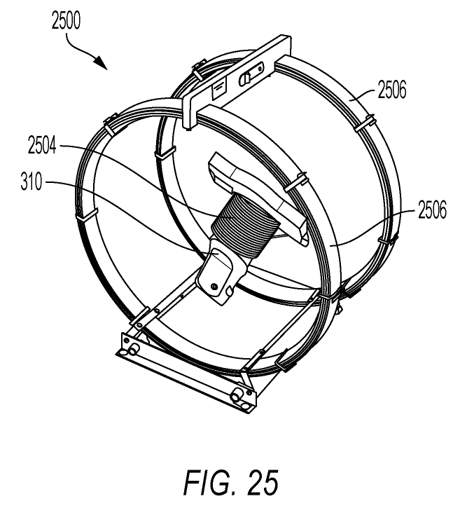

FIG. 25 illustrates an anvil sensing configuration including an air transformer 2500. The anvil 310 is wrapped in a passive coil 2504 that terminates at a resistance. Active coils 2506 positioned in the housing of the impact tool 100 are configured to sense changes in magnetic properties (magnetoelastic/magnetostriction) of the anvil 310 as it is impacted by the hammer 305. The passive coil 2504 (terminated with a resistance) on the anvil 310 and the active coils 2506 create an air transformer between a constant magnetic field produced by the active coils 2506 and the passive coil 2504 on the anvil 310. In the embodiment shown, two active coils 2506 are used to provide a more accurate torque determination by canceling out the effects of tension and compression in the magnetic field readings, as described with respect to FIG. 20. When the anvil 310 is impacted by the hammer 305 the active coils 2506 sense changes in the electromagnetic field of the passive coil 2504 due to torsion in the anvil 310. The controller 245 may be configured to determine a torque applied to the anvil 310 by correlating these changes in the electromagnetic field of the passive coil 2504 to changes in the magnetic properties of the anvil 310 caused by torsion. The controller 245 may also be configured to use the determined torsional strain amount to determine when to stop the motor 205, to reduce motor power to hit a predetermined, desired anvil torque, etc.

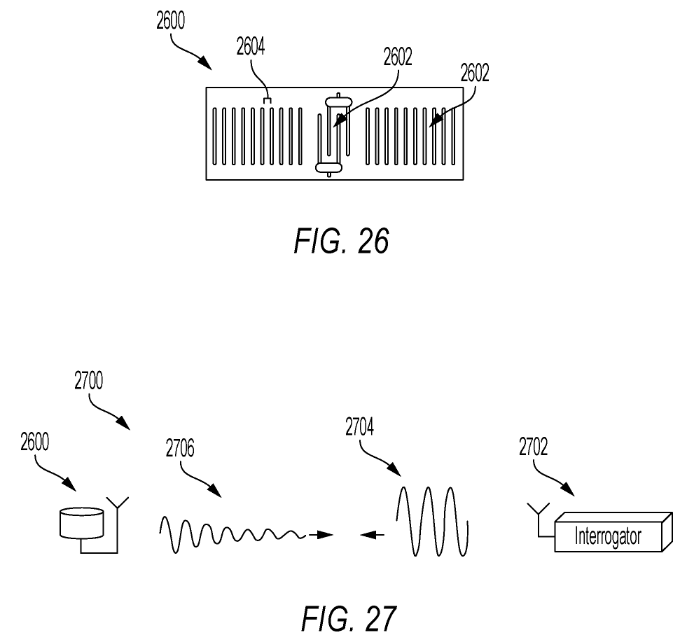

FIG. 26 illustrates a surface acoustic wave (“SAW”) sensor 2600. The SAW sensor includes elements 2602 having complex geometries that resonate at specific frequencies based on a spacing 2604 of the elements 2602. The SAW sensor may be placed along a direction of torsion of the anvil shaft such that, as torque is introduced to the anvil 310 when the hammer 305 strikes the anvil 310, the spacing 2604 grows or shrinks and affects the resonant frequencies of the elements 2602. The controller 245 may be configured to correlate these changes in the resonant frequencies of the elements 2602 to the torque applied to the anvil 310, and accordingly may be configured to determine the torque applied to the anvil 310. In some embodiments, the elements 2602 are mounted on a substrate of a material such as Quarts, Lithium niobate, or some other material. In some embodiments, the SAW sensor 2600 is used as strain sensor 225D (e.g., strain gauge 402, 502, 602, etc.).

FIG. 27 illustrates an interrogator 2700 (i.e., a wireless sensor interrogation system) configured to interrogate the SAW sensor 2600. An interrogator 2702 (e.g., antenna 412) transmits a radio frequency (“RF”) signal 2704 to the SAW sensor 2600. The SAW sensor 2600 receives the RF signal 2704 and transmits a sensor signal 2706 based on the complex geometry and spacing of the elements 2602 back to the interrogator 2702. In the embodiment shown, the interrogator 2702 is configured to communicate the sensor signal 2706 to the controller 245, and the controller 245 may be configured to determine a torque applied to the anvil 310 based on the sensor signal 2706. In some embodiments, antenna 412 may be configured to perform the functions of interrogator 2702.

In some embodiments, the SAW sensor 2600 includes two antennas, where one antenna is configured to receive the RF signal 2704 while the other antenna is dedicated to transmitting the sensor signal 2706. In such embodiments, the SAW sensor may therefore be capable of continuous wireless communication with the impact tool 100 (e.g., at antenna 412). In some embodiments, the SAW sensor 2600 only includes a single antenna configured to both receive the RF signal 2704 and transmit the sensor signal 2706.

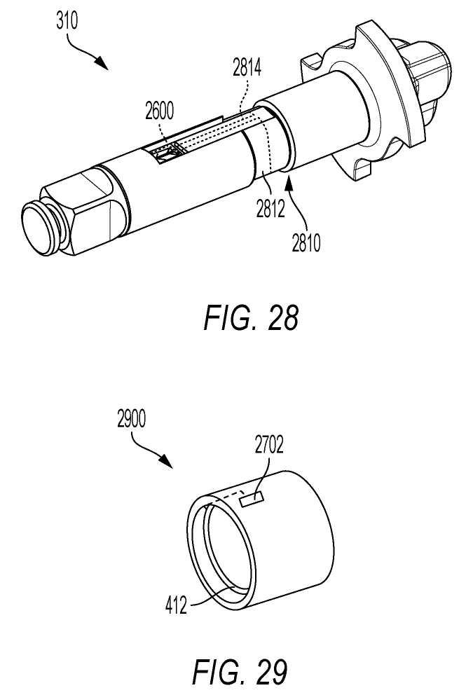

FIG. 28 illustrates a SAW sensor 2600 and antenna 2814 affixed to the anvil 310. The SAW sensor 2600 and the antenna 2814 are affixed to the anvil 310 (e.g., using a potting compound) within a channel 2810 defined in the surface of the anvil 310. In the embodiment shown, the antenna 2814 includes extensions 2812 which are also positioned in the channel 2810 and configured to wrap partially or fully around the circumference of the anvil 310. The extensions 2812 may be flexible and may include conductive material (e.g., metal wire, etc.) configured to perform the functions of antenna 410. In the embodiment shown, the extensions 2812 include traces (e.g., connected to antenna 2814) configured to have current induced therein by an incident electromagnetic field produced as described above (e.g., produced by antenna 412), and/or to transmit the sensor signal 2706 when energized as an extension of the SAW sensor 2600 (e.g., in response to the SAW sensor 2600 receiving the RF signal 2704).

FIG. 29 illustrates a sensor assembly 2900 equipped with the interrogator 2702 and configured to transmit the RF signal 2704 via antenna 412 to the SAW sensor 2600, and to receive the RF signal 2704 transmitted by the SAW sensor 2600 in response at antenna 412, as described above. The sensor assembly 2900 may be positioned in the housing of the impact tool 100 and connected to the controller 245. The controller 245 may be configured to determine a torque applied to the anvil 310 based on the sensor signal 2706 and to determine when to stop the motor 205 or to reduce motor power to hit a predetermined, desired anvil torque, based on the sensor signal 2706.

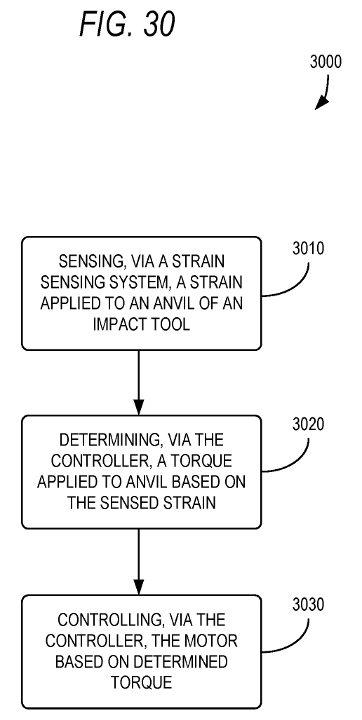

FIG. 30 illustrates a flowchart 3000 for a method of controlling a motor based on anvil strain resulting from an impact to an anvil 310 of an impact mechanism 300.

At block 3010, a strain sensor (e.g., strain gauge 402) senses a strain applied to an anvil 310 of an impact mechanism.

For example, a wirelessly powered strain gauge 402 affixed to an anvil 310 of an impact tool 100 may locally sense a strain experienced by a portion of an anvil 310 (e.g., measured at the anvil shaft) as a result of the anvil 310 being impacted by a hammer 305 of the impact tool 100.

Alternatively, sensors (e.g., magnetometers 1604, transmitting coil 2002 and receiving coils 2004, 2006, active coils 2506, etc.) may remotely measure the strain experienced by the anvil 310 as a result of the impact based on sensed changes in a magnetic property of the anvil 310 due to the strain.

Alternatively, the passive SAW sensor 2600 affixed to the anvil 310 may locally sense the strain experienced by the portion of the anvil 310 (e.g., measured at the anvil shaft) as a result of the impact.

At block 3020, a controller 245 of the impact tool 100 determines a torque applied to the anvil 310 as a result of the impact.

For example, an amplifier 404 connected to the strain gauge 402 and affixed to the anvil 310 may amplify an output signal of the strain gauge 402 for digitization by an ADC 406 connected to the amplifier 404. The ADC 406 may locally process the amplified signal to generate data, based on the amplified signal, an anvil torque, a peak anvil torque, a width of a torque pulse, an area under a torque pulse, and/or a shape of torque pulse. The ADC 406 converts the amplified signal to a digital signal for wireless transmission to the controller 245 and/or provides the generated data for wireless transmission to the controller 245. A wireless power and data transfer circuit 408 (e.g., an NFC circuit) included in the anvil and connected to the ADC 406 then wirelessly transmits the digitized signal and/or data received from the ADC 406 to the controller 245. The controller 245 may then determine the torque applied to the anvil 310 based on the signal and/or data received wirelessly (e.g., via antenna 412) from the ADC 406.

Alternatively, the anvil 310 may be permanently magnetized and magnetometers 1604 positioned in the housing of the impact tool 100 may sense changes in the magnetic fields 1606 of the anvil 310 due to the strain experienced by the anvil 310 as a result of the impact. The controller 245 may then determine the torque applied to the anvil 310 based on the strain sensed by the magnetometers 1604.

Alternatively, a transmitting coil 2002 and two receiving coils 2004, 2006 may be positioned at predetermined position around a circumference of the anvil 310. The transmitting coil 2002 may emit an electromagnetic field toward the surface of the anvil 310. The receiving coils each form a transformer with the transmitting coil 2002 and may experience voltage changes that can be related to the magnetic permeability of the anvil 310 changes due to strain. The controller 245 may then determine the torque applied to the anvil 310 based on the voltage changes in the receiving coils 2004, 2006.

Alternatively, active coils 2506 positioned in the housing of the impact tool 100 may form an air transformer with a passive coil affixed to the anvil 310. The active coils may sense changes in magnetic properties (magnetoelastic/magnetostriction) of the anvil 310 based on changes in the electrical properties of the air transformer as the anvil 310 by the hammer 305. The controller 245 may then determine the torque applied to the anvil 310 based on the changes in magnetic properties of the anvil 310 sensed by the magnetometers 1604.

Alternatively, a passive SAW sensor 2600 affixed to the anvil 310 may, a result of the torque applied to the anvil 310, have a spacing 2604 complex geometries change due to a stain experienced by the anvil 310. An interrogator 2702 of the impact tool 100 may interrogate the passive saw sensor with an RF signal 2704. In response to the RF signal 2704, the SAW sensor 2600 may emit a sensor signal 2706 indicating how the complex geometry and spacing of the elements 2602 have changed as a result of the strain experienced by the anvil 310. The interrogator 2702 may then receive the sensor signal 2706 and communicate it to the controller. The controller 245 may then determine the torque applied to the anvil 310 based on the changes in geometry and spacing of the SAW sensor 2600.

At block 3030, the controller 245 controls the motor 205 based on the determined torque applied to the anvil 310. For example, the controller 245 may control the motor 205 to stop, to reduce motor power to hit a predetermined, desired anvil torque, etc.

In some embodiments, the controller 245 is also configured to determine a torque applied to a joint via the anvil 310 based on the determined torque applied to the anvil 310. In some embodiments, the controller is configured to additionally determine a hammer rotation, a hammer translation, an anvil rotation, temperatures of the impact tool 100, motor speed/torque, etc., to derive determine a torque applied to a joint via the anvil 310.

Although the invention has been described in detail with reference to certain preferred embodiments, variations and modifications exist within the scope and spirit of one or more independent aspects of the invention as described. Various features and advantages are set forth in the following claims.

What is claimed is:

1. An impact tool comprising:
a trigger;
a motor including a motor shaft;
an impact mechanism including:
a hammer coupled to the motor shaft, and
an anvil configured to receive impacts from the hammer, the anvil including:
anvil lugs;
a shaft;
an anvil strain sensor configured to sense an anvil strain;
an amplifier connected to the anvil strain sensor;
an analog to digital converter connected to the amplifier; and
a wireless power and data transfer circuit;
an output drive device configured to be coupled to the anvil and configured to rotate to perform a task; and
a controller connected to the motor, the controller configured to:
receive an output signal from the trigger, and
determine an anvil torque based on the anvil strain.

2. The impact tool of claim 1, wherein the controller is further configured to control the motor to operate based on the output signal from the trigger and the anvil torque.

3. The impact tool of claim 1, further comprising:
a second anvil strain sensor positioned on a surface of the anvil.

4. The impact tool of claim 3, further comprising:
a third anvil strain sensor positioned on the surface of the anvil; and
a fourth anvil strain sensor positioned on the surface of the anvil.

5. The impact tool of claim 4, wherein the anvil strain sensor, the second anvil strain sensor, the third anvil strain sensor, and the fourth anvil strain sensor are configured as a Wheatstone bridge circuit.

6. The impact tool of claim 1, wherein the anvil strain sensor is a capacitive strain gauge.

7. The impact tool of claim 1, wherein:
the wireless power and data transfer circuit includes an antenna; and
the antenna includes a flexible substrate that is wrapped around a circumference of the anvil.

8. The impact tool of claim 7, wherein the antenna is configured to cover 180 degrees or more of the circumference of the anvil.

9. An impact tool comprising:
a trigger;
a motor including a motor shaft;
an impact mechanism including:
a hammer coupled to the motor shaft, and
an anvil configured to receive impacts from the hammer, the anvil including:
anvil lugs,
a shaft, and
an anvil strain sensor configured to sense an anvil strain;
an output drive device configured to be coupled to the anvil and configured to rotate to perform a task; and
a controller connected to the motor, the controller configured to:
receive an output signal from the trigger,
determine an anvil torque based on the anvil strain, and
control the motor to operate based on the output signal from the trigger and the anvil torque.

10. The impact tool of claim 9, further comprising:
a wireless power and data transfer circuit.

11. The impact tool of claim 10, wherein the wireless power and data transfer circuit includes one selected from a group consisting of: a capacitive coupling circuit and an inductive coupling circuit.

12. The impact tool of claim 10, wherein:
the wireless power and data transfer circuit includes an antenna; and
the antenna includes a flexible substrate that is wrapped around a circumference of the anvil.

13. The impact tool of claim 12, wherein the antenna is configured to cover 180 degrees or more of the circumference of the anvil.

14. The impact tool of claim of claim 9, wherein the anvil strain sensor is adhered to the anvil.

15. A method of controlling an impact tool, the method comprising:
sensing, via a strain sensing system, a strain applied to an anvil of the impact tool;
determining, via a controller, a torque applied to anvil based on the strain; and
controlling, via the controller, a motor of the impact tool based on determined torque.

16. The method of claim 15, further comprising:
transferring, using a wireless power transfer circuit, power to the anvil.

17. The method of claim 16, wherein the wireless power transfer circuit includes one selected from a group consisting of: a capacitive coupling circuit and an inductive coupling circuit.

18. The method of claim 15, further comprising:
transferring, a wireless data transfer circuit, data from the anvil to a controller of the impact tool.

19. The method of claim 18, wherein a data transfer rate of the wireless data transfer circuit is between 200 kilo-bytes per second (“kbps”) and 1000kbps.

20. The method of claim 15, further comprising:
receiving an output signal from a trigger; and
controlling the motor based on the output signal from the trigger.
